(19) United States
(12) Patent Application Publication
(10) Pub. No.: US 2018/0005271 A1
(43) Pub. Date: Jan. 4, 2018

(54) INFORMATION PROCESSING METHOD, SERVER, AND COMPUTER STORAGE MEDIUM

(71) Applicant: Tencent Technology (Shenzhen) Company Limited, Shenzhen (CN)

(72) Inventors: Nan HE, Shenzhen (CN); Bo ZHANG, Shenzhen (CN); Yanmin WANG, Shenzhen (CN); Min CHEN, Shenzhen (CN); Zhe FENG, Shenzhen (CN); Liangdong WANG, Shenzhen (CN); Zhihui JIN, Shenzhen (CN); Qiyun SU, Shenzhen (CN); Mengting JIANG, Shenzhen (CN)

(73) Assignee: Tencent Technology (Shenzhen) Company Limited, Shenzhen (CN)

(21) Appl. No.: 15/708,807

(22) Filed: Sep. 19, 2017

Related U.S. Application Data
(63) Continuation of application No. PCT/CN2016/080081, filed on Apr. 22, 2016.

(30) Foreign Application Priority Data
Dec. 15, 2015 (CN) 201510939359.X

(51) Int. Cl. G06Q 30/02; G06Q 50/00

(52) U.S. Cl. CPC G06Q 30/0267; G06Q 30/0269; G06Q 50/01

(57) ABSTRACT

An information processing method, a server, and a computer storage medium are disclosed. The method includes: obtaining first information from a first terminal, the first information including at least information content and an information presentation style parameter; obtaining second information from the second terminal, the second information including at least basic user information and/or user behavior information and/or user relationship chain information; generating sampling information according to the first information and the second information, and constructing, according to the sampling information, at least one processing policy that separately corresponds to a first type of processing node interacting with the first terminal and a second type of processing node interacting with the second terminal; and generating the third information according to the first information and the at least one processing policy, and sending the third information to the second terminal for information presentation.

### RELATED APPLICATION

This application is a continuation application of PCT Patent Application No. PCT/CN2016/080081, filed on Apr. 22, 2016, which claims priority to Chinese Patent Application No. 201510939359.X, filed with the Chinese Patent Office on Dec. 15, 2015, both of which are incorporated herein by reference in their entireties.

### FIELD OF THE TECHNOLOGY

The present disclosure relates to the communications technologies, and in particular, to an information processing method, a server, and a computer storage medium.

### BACKGROUND OF THE DISCLOSURE

There exist a variety of information sharing methods. For example, when reading a piece of great news, a user may forward the news by using a micro blog. This is a type of information sharing. Another example, when watching a video, in addition to a video program intended to watch, a user may further see some inserted advertisement recommendations, hot news, or headline news prompts. This is also a type of information sharing. Another example, when browsing a web page, in addition to information being browsed, a user may further obtain information related to the browsed information. Another example, the user browses a shopping website, and intends to buy shoes of a particular brand, when obtaining information about the shoes of the brand, the user may further obtain information about shoes of other similar styles or the same style in this or another shopping website. This is still a type of information sharing. When receiving a particular piece of information, users may further receive other related or different information recommendations. These methods may be collectively referred to as information sharing recommendation methods in information sharing methods.

In a scenario in which an information sharing recommendation method is used, a user usually receives information sharing recommendation in which the user is not interested. If the user click to actively close the information sharing recommendation, the information is no longer recommended to and shared with the user in a period of time. If the user does not click to actively close the information sharing recommendation, the information is always recommended to and shared with the user. However, information content needed by a user cannot be effectively provided to the user in the targeted recommendation mechanism of only responding to a user feedback having an active click. That is, there exists a problem that information sharing recommendation is insufficient and/or is not precise. An effective solution has not been proposed for this problem.

### SUMMARY

In view of this, embodiments of the present disclosure intend to provide an information processing method, a terminal, and a computer storage medium, to at least resolve the problem in the existing technology, and targetedly provide precise information recommendation content to a user.

The technical solutions in the embodiments of the present disclosure are implemented as such:

An embodiment of the present disclosure discloses an information processing method, including:

obtaining, by a device comprising a memory and a processor in communication with the processor, first information from a first terminal, the first information comprising at least information content and an information presentation style parameter;

obtaining, by the device, second information from a second terminal, the second information comprising at least one of:
basic user information,
user behavior information, or
user relationship chain information;

generating, by the device, sampling information according to the first information and the second information;

constructing, by the device according to the sampling information, at least one processing policy that separately corresponds to a first type of processing node interacting with the first terminal and a second type of processing node interacting with the second terminal;

generating, by the device according to the first information and the at least one processing policy, third information comprising presentation information for the second terminal; and

sending, by the device, the third information to the second terminal for information presentation.

An embodiment of the present disclosure further discloses an apparatus, the apparatus comprising:

a memory storing instructions;

a processor in communication with the memory, wherein, when the processor executes the instructions, the processor is configured to cause the apparatus to:
obtain first information from a first terminal, the first information comprising at least information content and an information presentation style parameter;
obtain second information from a second terminal, the second information comprising at least one of:
   basic user information,
   user behavior information, or
   user relationship chain information;
generate sampling information according to the first information and the second information;
construct, according to the sampling information, at least one processing policy that separately corresponds to a first type of processing node interacting with the first terminal and a second type of processing node interacting with the second terminal;
generate third information comprising presentation information for the second terminal according to the first information and the at least one processing policy; and
send the third information to the second terminal for information presentation.

An embodiment of the present disclosure provides a non-transitory computer readable storage medium storing computer executable instructions, wherein, the computer executable instructions, when executed by one or more processors, are configured to cause the one or more processors to perform:

obtaining first information from a first terminal, the first information comprising at least information content and an information presentation style parameter;

obtaining second information from a second terminal, the second information comprising at least one of:
basic user information,
user behavior information, or
user relationship chain information;

generating sampling information according to the first information and the second information;

constructing, according to the sampling information, at least one processing policy that separately corresponds to a first type of processing node interacting with the first terminal and a second type of processing node interacting with the second terminal;

generating, according to the first information and the at least one processing policy, third information comprising presentation information for the second terminal; and

sending the third information to the second terminal for information presentation.

The method in the embodiments of the present disclosure includes: obtaining first information from a first terminal, the first information including at least information content and an information presentation style parameter, to generate third information presented to a second terminal; obtaining second information from the second terminal, the second information including at least basic user information and/or user behavior information and/or user relation chain information; generating sampling information according to the first information and the second information, and constructing, according to the sampling information, at least one processing policy that separately corresponds to a first type of processing node interacting with the first terminal and a second type of processing node interacting with the second terminal; and generating the third information according to the first information and the at least one processing policy, and sending the third information, to provide the third information to the second terminal for information presentation.

By means of the embodiments of the present disclosure, the sampling information is generated by using the first information and the second information, the at least one processing policy that separately corresponds to the first type of processing node interacting with the first terminal and the second type of processing node interacting with the second terminal is constructed according to the sampling information, and the third information provided to the second terminal for information presentation is generated according to the processing policy. Such a global processing policy for information collection and targeted information pushing can provide precise information recommendation content to a user.

### BRIEF DESCRIPTION OF THE DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may derive other drawings from these accompanying drawings.

FIG. 1 is a schematic diagram of hardware entities of parties performing information interaction according to an embodiment of present disclosure;

FIG. 2 is a schematic diagram of an implementation process according to Embodiment 1 of the present disclosure;

FIG. 3 is a schematic diagram of an application scenario of processing nodes in an advertisement life cycle according to Embodiment 1 of the present disclosure;

FIG. 4 is a schematic diagram of an implementation process according to Embodiment 2 of the present disclosure;

FIG. 5 is a schematic diagram of an implementation process according to Embodiment 3 of the present disclosure;

FIG. 6A is a schematic diagram of an implementation process according to Embodiment 4 of the present disclosure;

FIG. 6B is a schematic diagram of an application scenario of an advertisement queue to which an embodiment of the present disclosure is applied;

FIG. 7 is a schematic diagram of a compositional structure according to Embodiment 5 of the present disclosure;

FIG. 8 is a schematic diagram of a hardware compositional structure according to Embodiment 6 of the present disclosure;

FIG. 9 is a schematic diagram of an application scenario of a negative feedback entrance according to an embodiment of the present disclosure;

FIG. 10 is a schematic diagram of an application scenario of multiple advertisement positions on a page according to an embodiment of the present disclosure;

FIG. 11 is a schematic diagram of another application scenario of a negative feedback entrance according to an embodiment of the present disclosure; and

FIG. 12 is a schematic diagram of a hardware entity of a server according to Embodiment 7 of the present disclosure.

### DESCRIPTION OF EMBODIMENTS

The implementation of the technical solutions is described in further detail with reference to the accompanying drawings.

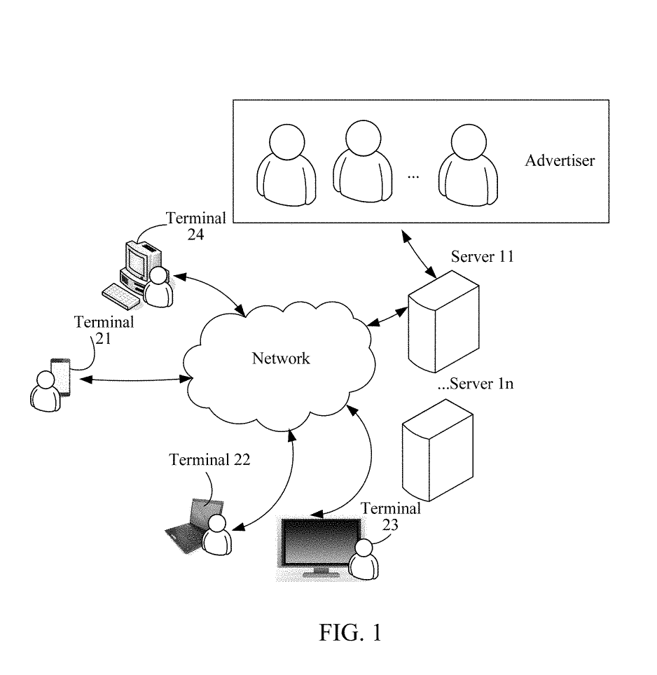

FIG. 1 is a schematic diagram of hardware entities of performing information interaction according to an embodiment of present disclosure. FIG. 1 includes servers 11, . . . , and 1n and terminal devices 21 to 24. The terminal devices 21 to 24 perform information interaction with the servers by using a wired network or a wireless network. The terminal devices include types such as a mobile phone, a desktop computer, a PC, and an all-in-one computer. In an example, the servers 11, . . . , and 1n may further interact with a first type of terminal (for example, a terminal of an advertiser, or referred to as an object providing advertisement material and content for promotion) by using a network. After the first type of terminal submits an advertisement intended to be advertised, the advertisement is stored in a server cluster, and an administrator may be manned to perform a series of processing such as examination on the advertisement from the first type of terminal. Relative to the first type of terminal, the terminal devices 21 to 24 may be referred to as a second type of terminal (for example, terminals of common users, or referred to as objects for receiving advertisement presentation or exposure), and may be users watching videos by using video applications, users playing games by using game applications, or the like. Advertisements may be added to all applications or specified applications (for example, a game application, a video application, and a navigation application) installed on the terminal devices to present more recommendation information to the users. By using embodiments of the present disclosure, and based on the system shown in FIG. 1, first information is obtained from a first terminal, the first information including at least information content and an information presentation style parameter; second information is obtained from the second terminal, the second information including at least basic user information and/or user behavior information and/or user relationship chain information; sampling information is generated according to the first information and the second information. At least one processing policy is constructed according to the sampling information corresponding to processing nodes throughout an information life cycle in an information recommendation and sharing platform system. The third information is generated according to the first information and the at least one processing policy. The third information is sent to the second terminal for information presentation. Because the at least one processing policy that corresponds to the processing nodes throughout the information life cycle in the information recommendation and sharing platform system is used, for a scenario where presented information is final advertisement information, sampling is performed by taking into consideration both advertisement content advertised by a terminal of a frontend advertiser and user information of a backend advertisement presentation object. By constructing multiple processing policies throughout advertisement life stages in a platform ecological environment instead of considering only one processing policy in one link of user experience after advertisement exposure, according to at least one policy, the third information is generated for using as final information presentation, so that information presentation content is quite precise, thereby bringing a good targeted pushing effect, more targeted pushing, and higher pertinence. Further, an advertisement presentation feedback resulted from the second user terminal may further be collected, and iteratively fed back to the processing nodes throughout the information life cycle in the information recommendation and sharing platform system for modifying an established policy, thereby forming a closed-loop path for information collection, feedback, and optimization, and further improving processing efficiency and precision of targeted pushing.

The example in FIG. 1 is only an example of a system architecture for implementing the embodiments of the present disclosure. The embodiments of the present disclosure are not limited to the system structure shown in FIG. 1. Embodiments of the present disclosure are provided based on the system architecture.

### Embodiment 1

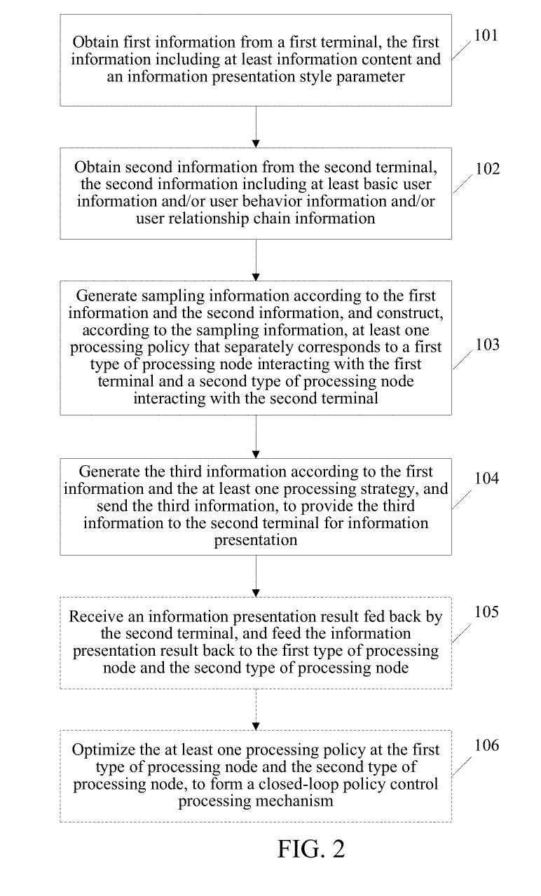

This embodiment of the present disclosure provides an information processing method. As shown in FIG. 2, the method includes:

Step 101. Obtain first information from a first terminal, the first information including at least information content and an information presentation style parameter.

Herein, the first terminal may be a terminal of an advertiser, or referred to as an object providing advertisement material and content for promotion. Information content, for example, advertisements, includes many types, for example, basic advertisement information such as representation elements (a spokesperson, an advertisement copy, music, and the like) included in an advertisement product; for example, brand information such as brand-related information conveyed by an advertisement or brand use experience in the memory of a customer; for example, requirement information about requirements for living activities or values satisfied by using a brand; for example, purchase activity information related to purchases or brand use of a customer. The information presentation style parameter refers to a manner in which advertisement information content is presented, for example, advertisement material such as whether the advertisement information content is presented in a dynamic form of a flash or presented in a static form of a gif, or a background color or background music of the advertisement information content.

Step 102. Obtain second information from the second terminal, the second information including at least basic user information and/or user behavior information and/or user relationship chain information.

Herein, the second terminal may be a terminal of a common user, or referred to as an object for receiving advertisement presentation or exposure. The basic user information includes, for example, the age, the gender, and the location of the user. The user behavior information includes, for example, whether the user is fond of shopping or fond of playing games, and whether the user is interested in particular advertisement information content. The user relationship chain information includes, for example, a QQ friend chain, a WeChat friend circle, friends in a QQ space, classmates in a senior high school, classmates in a university, and a circle of contacts.

Step 103. Generate sampling information according to the first information and the second information, and construct, according to the sampling information, at least one processing policy that separately corresponds to a first type of processing node interacting with the first terminal and a second type of processing node interacting with the second terminal.

Herein, the first type of processing node and the second type of processing node are located in an information recommendation and sharing platform system, and encompass processing nodes throughout an information life cycle in the information recommendation and sharing platform system.

Herein, the processing nodes throughout the information life cycle in the information recommendation and sharing platform system are divided into the first type of processing node and the second type of processing node. The first type of processing node includes at least one of the following:

1) a processing node corresponding to a stage at which a user of the first terminal is expanded, for example, a processing node corresponding to an advertiser providing a basic advertising service; or

2) a processing node corresponding to a stage at which the first information provided by a user of the first terminal is examined, for example, a processing node in the advertisement processing platform (for example, the GDT platform) that corresponds to operation, examination, an advertisement base, or indexing.

The second type of processing node includes at least one of the following:

1) a processing node corresponding to a stage at which a retrieval request of the second terminal is responded for primary selection of the first information, for example, a processing node in the advertisement processing platform (for example, the GDT platform) that corresponds to advertisement retrieval or primary selection;

2) a processing node corresponding to a stage at which a retrieval request of the second terminal is responded for fine selection and ranking of the first information, for example, a processing node in the advertisement processing platform (for example, the GDT platform) that corresponds to fine selection and ranking;

3) a processing node corresponding to a stage that is before the third information is sent to the second terminal for exposure, for example, a processing node in the advertisement processing platform (for example, the GDT platform) that corresponds to advertisement presentation; or

4) a processing node corresponding to a stage that is after the third information is sent to the second terminal for actual exposure, for example, a processing node corresponding to a user providing an advertising persona service.

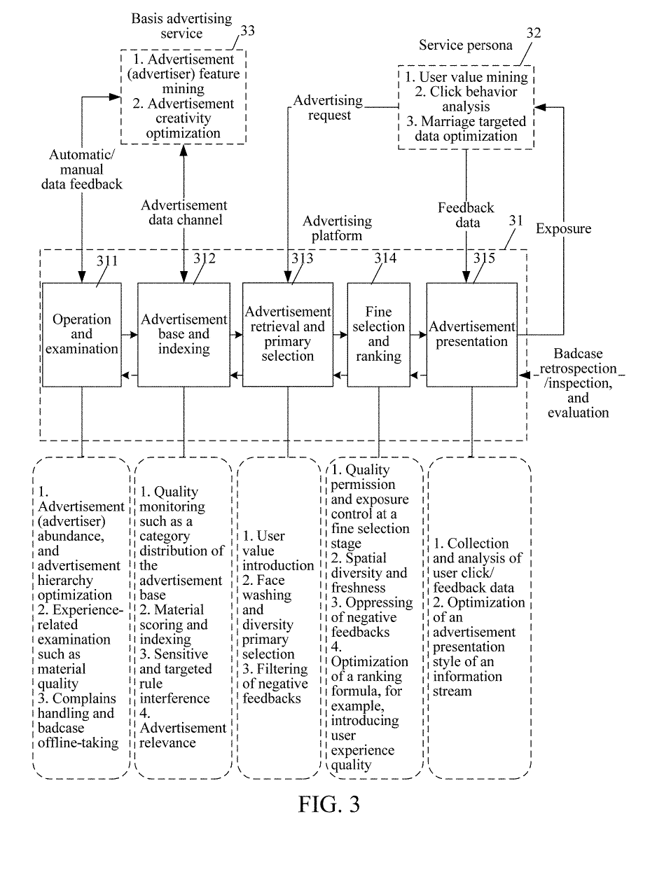

An instance related to the processing nodes and processing procedures thereof is shown in FIG. 3. FIG. 3 is a flowchart including the foregoing processing nodes according to this embodiment of the present disclosure by using an example in which recommended information is advertisement information. As shown in FIG. 3, a first terminal side, a second terminal side, and a platform side are included. The first terminal side is shown as a terminal 33. The terminal 33 is configured to provide a basic advertising service, and process policies such as advertisement (advertiser) feature mining and advertising creativity optimization, to provide advertisement information content to a platform 31 for processing. The terminal 33 is an instance of the advertiser in the infrastructure in FIG. 1. The second terminal side is shown as a terminal 32. The terminal 32 is configured to provide an advertising persona, and process policies such as user value mining, user click behavior analysis, and marriage targeted data optimization, to provide basic information, behavior information, and relationship chain information of a user to the platform 31 for processing. The terminal 32 is an instance of the terminals 21 to 24 in the infrastructure in FIG. 1. The platform 31 is configured to perform, by means of cooperative processing of a processing node 311 for operation and examination, a processing node 312 for storing advertisement information to form an advertisement base and create indexes, a processing node 313 for advertisement retrieval and advertisement information primary selection, a processing node 314 for fine selection and ranking of advertisement information qualified in primary selection, and a processing node 315 for advertisement presentation, advertisement information collection, screening, ranking, and integration of advertisement information in processing links, and collect presentation data that is after advertisement information is actually exposed and presented on the user side and other data for processing and analysis, so as to provide an optimized processing policy for better targeted advertising of advertisement information to the user side. The platform 31 is an instance of the servers 11 to 1n and the server cluster for examining the advertisement information provided by the advertiser in the infrastructure in FIG. 1.

A main processing policy of the processing node 311 for operation and examination is policy optimization for advertisement (advertiser) abundance and advertisement hierarchy, policy optimization for experience-related examination such as material quality, and policy optimization for complains handling and badcase offline-taking. The badcase refers to analyzing, during a search, an obviously incorrect ranking in a search result, to determine which ranking policy causes the incorrect ranking, and modifying a related matching parameter. Badcase means a bad case. After a large quantity of badcases are recorded, a large amount of case data may be collected by searching using search engines. If an inappropriate search result is encountered next time by using a search algorithm, the search result is verified by using features of these cases, and if a feature of the search result is similar to the features of these cases, the search algorithm is adjusted. In addition, auxiliary policy optimization is performed on the search algorithm by using a group of empirical parameters, and a policy is continuously adjusted in actual application, to ensure the credibility of a result. Features of a badcase mainly are: 1. a search result that does not satisfy experience of a search user; 2. behavior of a website in a search result is quite abnormal; and the like.

A main processing policy of the processing node 312 for storing advertisement information to form an advertisement base and create indexes is policy optimization for quality monitoring such as a category distribution of the advertisement base, policy optimization for material scoring and indexing, policy optimization for sensitive and targeted rule interference, and policy optimization for advertisement relevance.

A main processing policy of the processing node 313 for advertisement retrieval and advertisement information primary selection is policy optimization for user value introduction, policy optimization of face washing and diversity primary selection, and policy optimization for filtering of user negative feedbacks. The face washing refers to filtering some advertisements in candidate advertisements according to a service requirement (for example, an advertisement exceeds a budget allowance) and an advertising policy (for example, a relevance between an advertisement and a search context).

A main processing policy of the processing node 314 for fine selection and ranking of advertisement information qualified in primary selection is policy optimization for quality permission and exposure control at a fine selection stage, policy optimization for spatial diversity and freshness, policy optimization for oppressing of user negative feedbacks, and policy optimization for optimization of a ranking formula, for example, introducing user experience quality.

A main processing policy of the processing node 315 for advertisement presentation is policy optimization for collection and analysis of user click/feedback data and policy optimization for an advertisement presentation style of advertisement information.

In this step, because sampling is performed by taking both advertisement information content advertised by a frontend advertiser and user information of a backend advertisement presentation object into consideration, to construct multiple processing policies throughout advertisement life stages in a platform ecological environment, instead of considering only one processing policy in one link of user experience after advertisement exposure. Therefore, such comprehensive policy optimization throughout the processing nodes in the information life cycle in the information recommendation and sharing platform system can better provide advertisement information to a user, and provide good data support for target expectation of improving targeted advertising and precise advertising.

Step 104. Generate the third information according to the first information and the at least one processing policy, and send the third information to the second terminal for information presentation.

Herein, after this step, the method further include:

Step 105. Receive an information presentation result from the second terminal, and feed the information presentation result back to the first type of processing node and the second type of processing node.

Step 106. Optimize the at least one processing policy at the first type of processing node and the second type of processing node, to form a closed-loop policy control processing mechanism.

Steps 105 to 106 are a cyclic iterative feedback mechanism. After comprehensive policy optimization is obtained by using step 101 to step 103, and after the third information generated according to the comprehensive policy optimization is provided, by using step 104, to the second terminal for presentation, presentation result data that is obtained after the third information is actually exposed and presented on the user side may further be collected by using the cyclic iterative feedback mechanism in steps 105 to 106, to feed the presentation result data to the processing nodes in the platform throughout the information life cycle in the information recommendation and sharing platform system, so as to further optimize and adjust the comprehensive policy, to provide better data support for target expectation of subsequently continuously improving targeted advertising and precise advertising.

In an implementation of Embodiment 1 of the present disclosure, the information processing method in this embodiment further includes: performing feature analysis on the first information in the sampling information, to generate a first feature set, and performing feature classification according to a feature attribute; performing data analysis on the second information in the sampling information, to generate a first data set, and performing data classification according to a data type; and establishing a targeted recommendation association according to the feature classification and the data classification, and iteratively feeding the targeted recommendation association back to the processing nodes in the information life cycle in the information recommendation and sharing platform system (including the first type of processing node and the second type of processing node).

### Embodiment 2

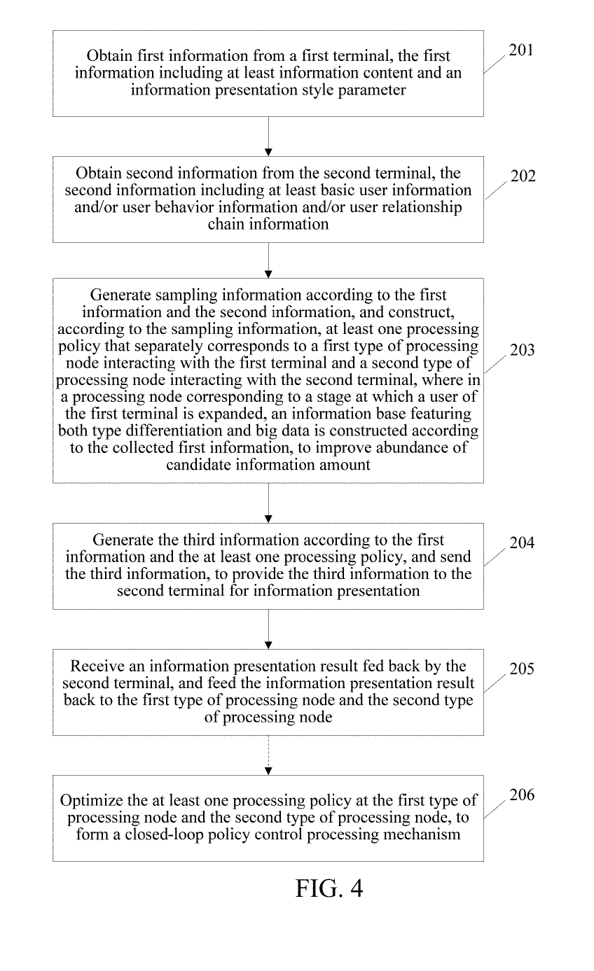

This embodiment of the present disclosure provides an information processing method. As shown in FIG. 4, the method includes:

Step 201. Obtain first information from a first terminal, the first information including at least information content and an information presentation style parameter.

Herein, the first terminal may be a terminal of an advertiser, or referred to as an object providing advertisement material and content for promotion. Information content, for example, advertisements, includes many types, for example, basic advertisement information such as representation elements (a spokesperson, an advertisement copy, music, and the like) included in an advertisement product; for example, brand information such as brand-related information conveyed by an advertisement or brand use experience in the memory of a customer; for example, requirement information about requirements for living activities or values satisfied by using a brand; for example, purchase activity information related to purchases or brand use of a customer. The information presentation style parameter refers to a manner in which advertisement information content is presented, for example, advertisement material such as whether the advertisement information content is presented in a dynamic form of a flash or presented in a static form of a gif, or a background color or background music of the advertisement information content.

Step 202. Obtain second information from the second terminal, the second information including at least basic user information and/or user behavior information and/or user relationship chain information.

Herein, the second terminal may be a terminal of a common user, or referred to as an object for receiving advertisement presentation or exposure. The basic user information includes, for example, the age, the gender, and the location of the user. The user behavior information includes, for example, whether the user is fond of shopping or fond of playing games, and whether the user is interested in particular advertisement information content. The user relationship chain information includes, for example, a QQ friend chain, a WeChat friend circle, friends in a QQ space, classmates in a senior high school, classmates in a university, and a circle of contacts.

Step 203. Generate sampling information according to the first information and the second information, and construct, according to the sampling information, at least one processing policy that separately corresponds to a first type of processing node interacting with the first terminal and a second type of processing node interacting with the second terminal, where in a processing node corresponding to a stage at which a user of the first terminal is expanded, an information base featuring both type differentiation and big data is constructed according to the first information , to improve abundance of candidate information amount.

Herein, this step 203 may also be replaced as: differentiating a priority of a user of the first terminal in a processing node corresponding to a stage at which the first information provided by the user of the first terminal is examined, to implement hierarchal management of users, and performing estimation and targeted relevance prediction on information content of the first information according to a quality index, to obtain candidate information of high quality and accurately targeted.

Herein, this step 203 may also be replaced as: differentiating, in a processing node corresponding to a stage at which a retrieval request of the second terminal is responded for primary selection of the first information, a type of a user value to initially achieve spatial diversity of candidate information.

Herein, this step may also be replaced as: performing, in a processing node corresponding to a stage at which a retrieval request of the second terminal is responded for fine selection and ranking of the first information, diversity optimization on spatial differentiation of candidate information according to a second preset rule based on multiple candidate information positions displayed on a page, and performing formal uniformization on the candidate information in space and time.

Herein, this step may also be replaced as: in a processing node corresponding to a stage at which a retrieval request of the second terminal is responded for fine selection and ranking of the first information, setting a first time period T0 and/or a second time period T1, where T1>T0; collecting a negative feedback request reported by the second terminal, where the negative feedback request is generated in response to a user closes one or more pieces of presented specified information; performing negative feedback filtering when it is detected that it is currently within the first time period T0, skipping returning the one or more pieces of presented specified information within the first time period T0; and performing negative feedback filtering when it is detected that it is currently within the second time period T1, supporting returning the one or more pieces of presented specified information within the second time period T1, and gradually reducing a quantity of returning times or returning frequency or a specific quantity of the returned pieces of presented specified information according to a time control factor.

In this step 203, the foregoing technical implementation of the processing node corresponding to the stage at which the user of the first terminal is expanded, the foregoing technical implementation of the processing node corresponding to the stage at which the first information provided by the user of the first terminal is examined, the foregoing technical implementation of the processing node corresponding to the stage at which the retrieval request of the second terminal is responded for primary selection of the first information, and the foregoing technical implementation of the processing node corresponding to the stage at which the retrieval request of the second terminal is responded for fine selection and ranking of the first information may also be combined to form an integrated policy for optimization. It should be noted that, these policy optimization is not limited to be performed in the corresponding processing node currently described, but also may be performed in another processing node. For example, the performing diversity optimization on spatial differentiation of the candidate information according to the second preset rule based on the multiple candidate information positions displayed on the page, and performing formal uniformization on the candidate information in space and time is not limited to be implemented in the processing node corresponding to the stage at which the retrieval request of the second terminal is responded for fine selection and ranking of the first information, but also may be implemented in the processing node corresponding to the stage at which the retrieval request of the second terminal is responded for primary selection of the first information.

Herein, the first type of processing node and the second type of processing node are located in an information recommendation and sharing platform system, and encompass processing nodes in an information life cycle in the information recommendation and sharing platform system.

Herein, the processing nodes throughout the information life cycle in the information recommendation and sharing platform system are divided into the first type of processing node and the second type of processing node. The first type of processing node includes at least one of the following:

1) a processing node corresponding to a stage at which a user of the first terminal is expanded, for example, a processing node corresponding to an advertiser providing a basic advertisement service; or

2) a processing node corresponding to a stage at which the first information provided by a user of the first terminal is examined, for example, a processing node in the advertisement processing platform (for example, the GDT platform) that corresponds to operation, examination, an advertisement base, or indexing.

The second type of processing node includes at least one of the following:

1) a processing node corresponding to a stage at which a retrieval request of the second terminal is responded for primary selection of the first information, for example, a processing node in the advertisement processing platform (for example, the GDT platform) that corresponds to advertisement retrieval or primary selection;

2) a processing node corresponding to a stage at which a retrieval request of the second terminal is responded for fine selection and ranking of the first information, for example, a processing node in the advertisement processing platform (for example, the GDT platform) that corresponds to fine selection and ranking;

3) a processing node corresponding to a stage that is before the third information is sent to the second terminal for exposure, for example, a processing node in the advertisement processing platform (for example, the GDT platform) that corresponds to advertisement presentation; or

4) a processing node corresponding to a stage that is after the third information is sent to the second terminal for actual exposure, for example, a processing node corresponding to a user providing an advertising persona service.

An example related to the processing nodes and processing procedures thereof is shown in FIG. 3. FIG. 3 is a flowchart including the foregoing processing nodes according to this embodiment of the present disclosure by using an example in which recommended information is advertisement information. As shown in FIG. 3, a first terminal side, a second terminal side, and a platform side are included. The first terminal side is shown as a terminal 33. The terminal 33 is configured to provide a basic advertising service, and process policies such as advertisement (advertiser) feature mining and advertising creativity optimization, to provide advertisement information content to a platform 31 for processing. The terminal 33 is an instance of the advertiser in the infrastructure in FIG. 1. The second terminal side is shown as a terminal 32. The terminal 32 is configured to provide an advertising persona, and process policies such as user value mining, user click behavior analysis, and marriage targeted data optimization, to provide basic information, behavior information, and relationship chain information of a user to the platform 31 for processing. The terminal 32 is an instance of the terminals 21 to 24 in the infrastructure in FIG. 1. The platform 31 is configured to perform, by means of cooperative processing of a processing node 311 for operation and examination, a processing node 312 for storing advertisement information to form an advertisement base and create indexes, a processing node 313 for advertisement retrieval and advertisement information primary selection, a processing node 314 for fine selection and ranking of advertisement information qualified in primary selection, and a processing node 315 for advertisement presentation, advertisement information collection, screening, ranking, and integration of advertisement information in processing links, and collect presentation data that is after advertisement information is actually exposed and presented on the user side and other data for processing and analysis, so as to provide an optimized processing policy for better targeted advertising of advertisement information to the user side. The platform 31 is an instance of the servers 11 to 1n and the server cluster for examining the advertisement information provided by the advertiser in the infrastructure in FIG. 1.

A main processing policy of the processing node 311 for operation and examination is policy optimization for advertisement (advertiser) abundance and advertisement hierarchy, policy optimization for experience-related examination such as material quality, and policy optimization for complains handling and badcase offline-taking. The badcase refers to analyzing, during a search, an obviously incorrect ranking in a search result, to determine which ranking policy causes the incorrect ranking, and modifying a related matching parameter. Badcase means a bad case. After a large quantity of badcases are recorded, a large amount of case data may be collected by searching using search engines. If an inappropriate search result is encountered next time by using a search algorithm, the search result is verified by using features of these cases, and if a feature of the search result is similar to the features of these cases, the search algorithm is adjusted. In addition, auxiliary policy optimization is performed on the search algorithm by using a group of empirical parameters, and a policy is continuously adjusted in actual application, to ensure the credibility of a result. Features of a badcase mainly are: 1. a search result that does not satisfy experience of a search user; 2. behavior of a website in a search result is quite abnormal; and the like.

A main processing policy of the processing node 312 for storing advertisement information to form an advertisement base and create indexes is policy optimization for quality monitoring such as a category distribution of the advertisement base, policy optimization for material scoring and indexing, policy optimization for sensitive and targeted rule interference, and policy optimization for advertisement relevance.

A main processing policy of the processing node 313 for advertisement retrieval and advertisement information primary selection is policy optimization for user value introduction, policy optimization of face washing and diversity primary selection, and policy optimization for filtering of user negative feedbacks.

A main processing policy of the processing node 314 for fine selection and ranking of advertisement information qualified in primary selection is policy optimization for quality access and exposure control at a fine selection stage, policy optimization for spatial diversity and freshness, policy optimization for oppressing of user negative feedbacks, and policy optimization for optimization of a ranking formula, for example, introducing user experience quality.

A main processing policy of the processing node 315 for advertisement presentation is policy optimization for collection and analysis of user click/feedback data and policy optimization for an advertisement presentation style of advertisement information.

In this step, because sampling is performed by taking both advertisement information content advertised by a frontend advertiser and user information of a backend advertisement presentation object into consideration, to construct multiple processing policies throughout advertisement life stages in a platform ecological environment, instead of considering only one processing policy in one link of user experience after advertisement exposure. Therefore, such comprehensive policy optimization throughout the processing nodes in the information life cycle in the information recommendation and sharing platform system can better provide advertisement information to a user, and provide good data support for target expectation of improving targeted advertising and precise advertising.

Step 204. Generate the third information according to the first information and the at least one processing policy, and send the third information to the second terminal for information presentation.

Herein, after this step, the method further include:

Step 205. Receive an information presentation result from the second terminal, and feed the information presentation result back to the first type of processing node and the second type of processing node.

Step 206. Optimize the at least one processing policy at the first type of processing node and the second type of processing node, to form a closed-loop policy control processing mechanism.

Steps 205 to 205 are a cyclic iterative feedback mechanism. After comprehensive policy optimization is obtained by using step 201 to step 203, and after the third information generated according to the comprehensive policy optimization is provided, by using step 204, to the second terminal for presentation, presentation result data that is obtained after the third information is actually exposed and presented on the user side may further be collected by using the cyclic iterative feedback mechanism in steps 205 to 106, to feed the presentation result data to the processing nodes in the platform throughout the information life cycle in the information recommendation and sharing platform system, so as to further optimize and adjust the comprehensive policy, to provide better data support for target expectation of subsequently continuously improving targeted advertising and precise advertising.

In an implementation of this embodiment of the present disclosure, the information processing method in this embodiment further includes: performing feature analysis on the first information in the sampling information, to generate a first feature set, and performing feature classification according to a feature attribute; performing data analysis on the second information in the sampling information, to generate a first data set, and performing data classification according to a data type; and establishing a targeted recommendation association according to the feature classification and the data classification, and iteratively feeding the targeted recommendation association back to the processing nodes in the information life cycle in the information recommendation and sharing platform system (including the first type of processing node and the second type of processing node).

### Embodiment 3

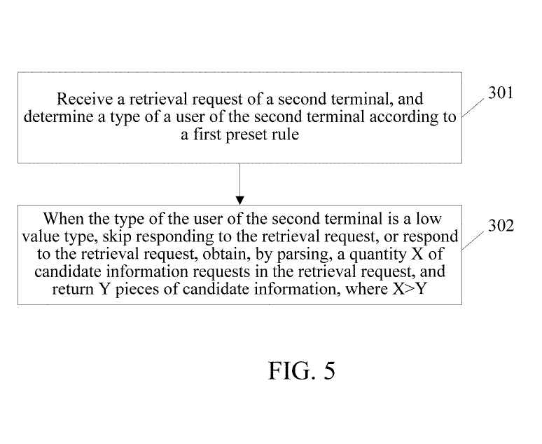

Based on the foregoing Embodiment 1 and Embodiment 2, in the information processing method in this embodiment of the present disclosure, in a processing node corresponding to a stage at which a retrieval request of a second terminal is responded for primary selection of first information, a type of a user value is differentiated to initially achieve spatial diversity of candidate information. Specifically, as shown in FIG. 5, the following implementation flowchart is used for implementation:

Step 301. Receive a retrieval request of a second terminal, and determine a type of a user of the second terminal according to a first preset rule.

Step 302. When the type of the user of the second terminal is a low value type, skip responding to the retrieval request, or respond to the retrieval request, obtain, by parsing, a quantity X of candidate information requests in the retrieval request, and return Y pieces of candidate information, where X>Y.

Herein, this step may also be understood as: for a user of a low value, skipping returning advertisement information or reducing a quantity of returned pieces of advertisement information.

When the type of the user of the second terminal is a high value type, the retrieval request is responded to, a quantity M of candidate information requests in the retrieval request are obtained by parsing, and N pieces of candidate information are returned, where M<N.

Herein, this step may also be understood as: for a user of a high value, returning more advertisement information.

### Embodiment 4

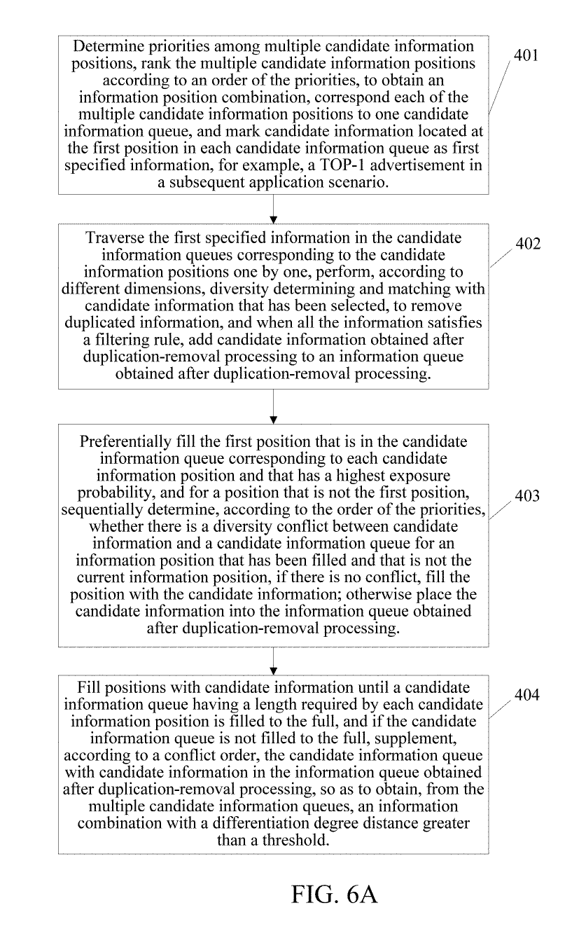

Based on the foregoing Embodiment 1, Embodiment 2, and Embodiment 3, in the information processing method in this embodiment of the present disclosure, in a processing node corresponding to a stage at which a retrieval request of a second terminal is responded for fine selection and ranking of first information, diversity optimization is performed on spatial differentiation of candidate information according to a second preset rule based on multiple candidate information positions displayed on a page, and formal uniformization is performed on the candidate information in space and time. Specifically, the following implementation flowchart in FIG. 6A is used for implementation:

Step 401. Determine priorities among multiple candidate information positions, rank the multiple candidate information positions according to an order of the priorities, to obtain an information position combination, correspond each of the multiple candidate information positions to one candidate information queue, and mark candidate information located at the first position in each candidate information queue as first specified information, for example, a TOP-1 advertisement in a subsequent application scenario.

Step 402. Traverse the first specified information in the candidate information queues corresponding to the candidate information positions one by one, perform, according to different dimensions, diversity determining and matching with candidate information that has been selected, to remove duplicated information, and when all the information satisfies a filtering rule, add candidate information obtained after duplication-removal processing to an information queue obtained after duplication-removal processing.

Step 403. Preferentially fill the first position that is in the candidate information queue corresponding to each candidate information position and that has a highest exposure probability, and for a position that is not the first position, sequentially determine, according to the order of the priorities, whether there is a diversity conflict between candidate information and a candidate information queue for an information position that has been filled and that is not the current information position, if there is no conflict, fill the position with the candidate information; otherwise place the candidate information into the information queue obtained after duplication-removal processing.

Step 404. Fill positions with candidate information until a candidate information queue having a length required by each candidate information position is filled to the full, and if the candidate information queue is not filled to the full, supplement, according to a conflict order, the candidate information queue with candidate information in the information queue obtained after duplication-removal processing, so as to obtain, from the multiple candidate information queues, an information combination with a differentiation degree distance greater than a threshold.

An example in which candidate information is advertisement information is used. A specific instance related to an advertisement queue is shown in FIG. 6B. There is an advertisement base 41 formed by multiple initial candidate advertisement queues. pos_1 represents the first advertisement position on a page, pos_2 represents the second advertisement position on the page, and pos_3 represents the third advertisement position on the page. Each advertisement position corresponds to multiple pieces of advertisement information content. For example, more than one piece of advertisement information is included in all advertisement queues corresponding to pos_1, pos_2, and pos_3. Positions of first advertisement information respectively corresponding to pos_1, pos_2, and pos_3 are shown as 411. A duplication-removal module 42 is implemented by using multiple duplication-removal algorithms, for example, an Aid algorithm, a Targetid algorithm, an appid algorithm, a Uid algorithm, a SimPic algorithm, a Category algorithm, an ImgFinger algorithm, and a TitleSim algorithm, so as to avoid duplication of advertisement information. Therefore, duplicated advertisement information is filtered out by using these duplication-removal algorithms, so that advertisement information is unique. An information queue 43 (which may also become a supplementary queue) obtained after duplication-removal processing is finally obtained. The information queue 43 obtained after duplication-removal processing is used, when all advertisement information in a candidate advertisement queue is filtered out, to preferentially supplement advertisement information (AD) that is filtered out due to non-category-diversity. Generally speaking, the architecture in FIG. 6B is to screen duplicated advertisement information and advertisement information of a same category from the multiple candidate information queues, to obtain an information combination with a differentiation degree distance greater than a threshold, and use advertisement information with great differentiation and diversity for subsequent information advertising. If all advertisement information in the advertisement information base 41 is filtered out according to a filtering result, appropriate advertisement information is selected from the information queue 43 obtained after duplication-removal processing to add the advertisement information back to the advertisement information base 41.

The foregoing algorithms are described as follows:

The Aid algorithm refers to: a current advertisement is no longer added to a selected advertisement queue if an aid (a unique identifier of the advertisement) of the advertisement is the same with a particular aid of an advertisement in selected advertisements. The Targetid algorithm refers to: a current advertisement is no longer added to a selected advertisement queue if a targetid (an ID of a promoter) of the advertisement is the same with a particular targetid of an advertisement in selected advertisements. The appid algorithm refers to: a current advertisement is no longer added to a selected advertisement queue if an appid (an ID of application software) of the advertisement is the same with a particular appid of an advertisement in selected advertisements. The Uid algorithm refers to: a current advertisement is no longer added to a selected advertisement queue if a uid (an ID of an advertiser) of the advertisement is the same with a particular uid of an advertisement in selected advertisements. The SimPic algorithm refers to: a current advertisement is no longer added to a selected advertisement queue if material of the advertisement is the same with particular material of an advertisement in selected advertisements. The Category algorithm refers to: a current advertisement is no longer added to a selected advertisement queue if a category of the advertisement is the same with a particular category of an advertisement in selected advertisements. The ImgFinger algorithm refers to: a current advertisement is no longer added to a selected advertisement queue if an ImgFinger of the advertisement is the same with a particular ImgFinger of an advertisement in selected advertisements. The TitleSim algorithm refers to: a current advertisement is no longer added to a selected advertisement queue if a title of the advertisement is the same with a particular title of an advertisement in selected advertisements.

### Embodiment 5

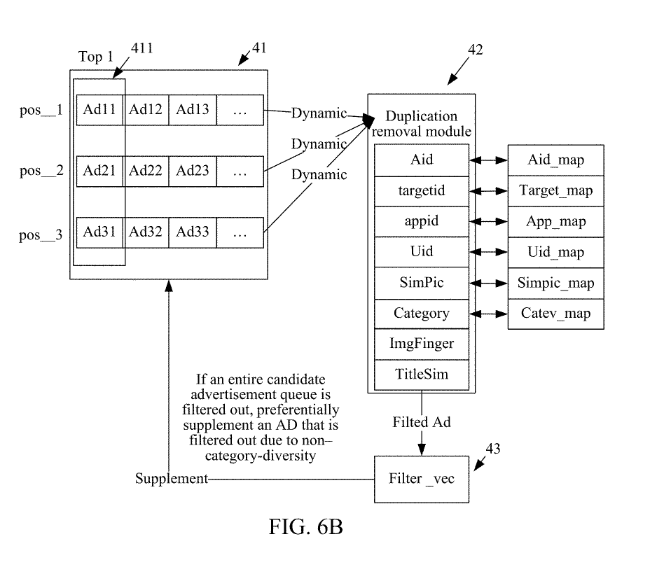

An embodiment of the present disclosure provides a server. As shown in FIG. 7, the server includes:

a first obtaining unit 51, configured to obtain first information from a first terminal, the first information including at least information content and an information presentation style parameter;

a second obtaining unit 52, configured to obtain second information from the second terminal, the second information including at least basic user information and/or user behavior information and/or user relationship chain information;

a policy construction unit 53, configured to: generate sampling information according to the first information and the second information, and construct, according to the sampling information, at least one processing policy that separately corresponds to a first type of processing node interacting with the first terminal and a second type of processing node interacting with the second terminal; and

a sending unit 54, configured to: generate the third information according to the first information and the at least one processing policy, and send the third information to the second terminal for information presentation.

Herein, the first terminal may be a terminal of an advertiser, or referred to as an object providing advertisement material and content for promotion. Information content, for example, advertisements, includes many types, for example, basic advertisement information such as representation elements (a spokesperson, an advertisement copy, music, and the like) included in an advertisement product; for example, brand information such as brand-related information conveyed by an advertisement or brand use experience in the memory of a customer; for example, requirement information about requirements for living activities or values satisfied by using a brand; for example, purchase activity information related to purchases or brand use of a customer. The information presentation style parameter refers to a manner in which advertisement information content is presented, for example, advertisement material such as whether the advertisement information content is presented in a dynamic form of a flash or presented in a static form of a gif, or a background color or background music of the advertisement information content.

Herein, the second terminal may be a terminal of a common user, or referred to as an object for receiving advertisement presentation or exposure. The basic user information includes, for example, the age, the gender, and the location of the user. The user behavior information includes, for example, whether the user is fond of shopping or fond of playing games, and whether the user is interested in particular advertisement information content. The user relationship chain information includes, for example, a QQ friend chain, a WeChat friend circle, friends in a QQ space, classmates in a senior high school, classmates in a university, and a circle of contacts.

Herein, the first type of processing node and the second type of processing node are located in an information recommendation and sharing platform system, and encompass processing nodes in an information life cycle in the information recommendation and sharing platform system.

Herein, the processing nodes throughout the information life cycle in the information recommendation and sharing platform system are divided into the first type of processing node and the second type of processing node. The first type of processing node includes at least one of the following:

1) a processing node corresponding to a stage at which a user of the first terminal is expanded, for example, a processing node corresponding to an advertiser providing a basic advertisement service; or

2) a processing node corresponding to a stage at which the first information provided by a user of the first terminal is examined, for example, a processing node in the advertisement processing platform (for example, the GDT platform) that corresponds to operation, examination, an advertisement base, or indexing.

The second type of processing node includes at least one of the following:

1) a processing node corresponding to a stage at which a retrieval request of the second terminal is responded for primary selection of the first information, for example, a processing node in the advertisement processing platform (for example, the GDT platform) that corresponds to advertisement retrieval or primary selection;

2) a processing node corresponding to a stage at which a retrieval request of the second terminal is responded for fine selection and ranking of the first information, for example, a processing node in the advertisement processing platform (for example, the GDT platform) that corresponds to fine selection and ranking;

3) a processing node corresponding to a stage that is before the third information is sent to the second terminal for exposure, for example, a processing node in the advertisement processing platform (for example, the GDT platform) that corresponds to advertisement presentation; or

4) a processing node corresponding to a stage that is after the third information is sent to the second terminal for actual exposure, for example, a processing node corresponding to a user providing an advertising persona service.

An example related to the processing nodes and processing procedures thereof is shown in FIG. 3. FIG. 3 is a flowchart including the foregoing processing nodes according to this embodiment of the present disclosure by using an example in which recommended information is advertisement information. As shown in FIG. 3, a first terminal side, a second terminal side, and a platform side are included. The first terminal side is shown as a terminal 33. The terminal 33 is configured to provide a basic advertising service, and process policies such as advertisement (advertiser) feature mining and advertising creativity optimization, to provide advertisement information content to a platform 31 for processing. The terminal 33 is an instance of the advertiser in the infrastructure in FIG. 1. The second terminal side is shown as a terminal 32. The terminal 32 is configured to provide an advertising persona, and process policies such as user value mining, user click behavior analysis, and marriage targeted data optimization, to provide basic information, behavior information, and relationship chain information of a user to the platform 31 for processing. The terminal 32 is an instance of the terminals 21 to 24 in the infrastructure in FIG. 1. The platform 31 is configured to perform, by means of cooperative processing of a processing node 311 for operation and examination, a processing node 312 for storing advertisement information to form an advertisement base and create indexes, a processing node 313 for advertisement retrieval and advertisement information primary selection, a processing node 314 for fine selection and ranking of advertisement information qualified in primary selection, and a processing node 315 for advertisement presentation, advertisement information collection, screening, ranking, and integration of advertisement information in processing links, and collect presentation data that is after advertisement information is actually exposed and presented on the user side and other data for processing and analysis, so as to provide an optimized processing policy for better targeted advertising of advertisement information to the user side. The platform 31 is an instance of the servers 11 to 1n and the server cluster for examining the advertisement information provided by the advertiser in the infrastructure in FIG. 1.

A main processing policy of the processing node 311 for operation and examination is policy optimization for advertisement (advertiser) abundance and advertisement hierarchy, policy optimization for experience-related examination such as material quality, and policy optimization for complains handling and badcase offline-taking. The badcase refers to analyzing, during a search, an obviously incorrect ranking in a search result, to determine which ranking policy causes the incorrect ranking, and modifying a related matching parameter. Badcase means a bad case. After a large quantity of badcases are recorded, a large amount of case data may be collected by searching using search engines. If an inappropriate search result is encountered next time by using a search algorithm, the search result is verified by using features of these cases, and if a feature of the search result is similar to the features of these cases, the search algorithm is adjusted. In addition, auxiliary policy optimization is performed on the search algorithm by using a group of empirical parameters, and a policy is continuously adjusted in actual application, to ensure the credibility of a result. Features of a badcase mainly are: 1. a search result that does not satisfy experience of a search user; 2. behavior of a website in a search result is quite abnormal; and the like.

A main processing policy of the processing node 312 for storing advertisement information to form an advertisement base and create indexes is policy optimization for quality monitoring such as a category distribution of the advertisement base, policy optimization for material scoring and indexing, policy optimization for sensitive and targeted rule interference, and policy optimization for advertisement relevance.

A main processing policy of the processing node 313 for advertisement retrieval and advertisement information primary selection is policy optimization for user value introduction, policy optimization of face washing and diversity primary selection, and policy optimization for filtering of user negative feedbacks.

A main processing policy of the processing node 314 for fine selection and ranking of advertisement information qualified in primary selection is policy optimization for quality access and exposure control at a fine selection stage, policy optimization for spatial diversity and freshness, policy optimization for oppressing of user negative feedbacks, and policy optimization for optimization of a ranking formula, for example, introducing user experience quality.

A main processing policy of the processing node 315 for advertisement presentation is policy optimization for collection and analysis of user click/feedback data and policy optimization for an advertisement presentation style of advertisement information.

In this step, because sampling is performed by taking both advertisement information content advertised by a frontend advertiser and user information of a backend advertisement presentation object into consideration, to construct multiple processing policies throughout advertisement life stages in a platform ecological environment, instead of considering only one processing policy in one link of user experience after advertisement exposure. Therefore, such comprehensive policy optimization throughout the processing nodes in the information life cycle in the information recommendation and sharing platform system can better provide advertisement information to a user, and provide good data support for target expectation of improving targeted advertising and precise advertising.

In an implementation of Embodiment 1 of the present disclosure, the server in this embodiment of the present disclosure further includes: an iterative feedback unit, configured to: receive an information presentation result from the second terminal, and feed the information presentation result back to the first type of processing node and the second type of processing node; and an optimization processing unit, configured to optimize the at least one processing policy at the first type of processing node and the second type of processing node, to form a closed-loop policy control processing mechanism.

In an implementation of Embodiment 1 of the present disclosure, the server in this embodiment of the present disclosure further includes: a first classification unit, configured to: perform feature analysis on the first information in the sampling information, to generate a first feature set, and perform feature classification according to a feature attribute; and a second classification unit, configured to: perform data analysis on the second information in the sampling information, to generate a first data set, and perform data classification according to a data type. The iterative feedback unit is further configured to: establish a targeted recommendation association according to the feature classification and the data classification, and iteratively feed the targeted recommendation association back to the processing nodes in the information life cycle in the information recommendation and sharing platform system (including the first type of processing node and the second type of processing node).

In an implementation of Embodiment 1 of the present disclosure, an instance related to the processing nodes and processing procedures thereof is shown in FIG. 3. FIG. 3 is a flowchart including the foregoing processing nodes according to this embodiment of the present disclosure by using an example in which recommended information is advertisement information. As shown in FIG. 3, a first terminal side, a second terminal side, and a platform side are included. The first terminal side is shown as a terminal 33. The terminal 33 is configured to provide a basic advertising service, and process policies such as advertisement (advertiser) feature mining and advertising creativity optimization, to provide advertisement information content to a platform 31 for processing. The terminal 33 is an instance of the advertiser in the infrastructure in FIG. 1. The second terminal side is shown as a terminal 32. The terminal 32 is configured to provide an advertising persona, and process policies such as user value mining, user click behavior analysis, and marriage targeted data optimization, to provide basic information, behavior information, and relationship chain information of a user to the platform 31 for processing. The terminal 32 is an instance of the terminals 21 to 24 in the infrastructure in FIG. 1. The platform 31 is configured to perform, by means of cooperative processing of a processing node 311 for operation and examination, a processing node 312 for storing advertisement information to form an advertisement base and create indexes, a processing node 313 for advertisement retrieval and advertisement information primary selection, a processing node 314 for fine selection and ranking of advertisement information qualified in primary selection, and a processing node 315 for advertisement presentation, advertisement information collection, screening, ranking, and integration of advertisement information in processing links, and collect presentation data that is after advertisement information is actually exposed and presented on the user side and other data for processing and analysis, so as to provide an optimized processing policy for better targeted advertising of advertisement information to the user side. The platform 31 is an instance of the servers 11 to 1n and the server cluster for examining the advertisement information provided by the advertiser in the infrastructure in FIG. 1.

A main processing policy of the processing node 311 for operation and examination is policy optimization for advertisement (advertiser) abundance and advertisement hierarchy, policy optimization for experience-related examination such as material quality, and policy optimization for complains handling and badcase offline-taking. The badcase refers to analyzing, during a search, an obviously incorrect ranking in a search result, to determine which ranking policy causes the incorrect ranking, and modifying a related matching parameter. Badcase means a bad case. After a large quantity of badcases are recorded, a large amount of case data may be collected by searching using search engines. If an inappropriate search result is encountered next time by using a search algorithm, the search result is verified by using features of these cases, and if a feature of the search result is similar to the features of these cases, the search algorithm is adjusted. In addition, auxiliary policy optimization is performed on the search algorithm by using a group of empirical parameters, and a policy is continuously adjusted in actual application, to ensure the credibility of a result. Features of a badcase mainly are: 1. a search result that does not satisfy experience of a search user; 2. behavior of a website in a search result is quite abnormal; and the like.

A main processing policy of the processing node 312 for storing advertisement information to form an advertisement base and create indexes is policy optimization for quality monitoring such as a category distribution of the advertisement base, policy optimization for material scoring and indexing, policy optimization for sensitive and targeted rule interference, and policy optimization for advertisement relevance.

A main processing policy of the processing node 313 for advertisement retrieval and advertisement information primary selection is policy optimization for user value introduction, policy optimization of face washing and diversity primary selection, and policy optimization for filtering of user negative feedbacks.

A main processing policy of the processing node 314 for fine selection and ranking of advertisement information qualified in primary selection is policy optimization for quality access and exposure control at a fine selection stage, policy optimization for spatial diversity and freshness, policy optimization for oppressing of user negative feedbacks, and policy optimization for optimization of a ranking formula, for example, introducing user experience quality.

A main processing policy of the processing node 315 for advertisement presentation is policy optimization for collection and analysis of user click/feedback data and policy optimization for an advertisement presentation style of advertisement information.

In an implementation of this embodiment of the present disclosure, in the server in this embodiment of the present disclosure, the policy construction unit is further configured to: create, in a processing node corresponding to a stage at which a user of the first terminal is expanded, an information base featuring both type differentiation and big data according to the first information, to improve abundance of candidate information amount; and/or differentiate a priority of a user of the first terminal in a processing node corresponding to a stage at which the first information provided by the user of the first terminal is examined, to implement hierarchal management of users, and perform estimation and targeted relevance prediction on information content of the first information according to a quality index, to obtain candidate information of high quality and accurately targeted.

The policy construction unit may further include multiple alternative and combinational schemes.

Herein, the policy construction unit may further be configured to: differentiate, in a processing node corresponding to a stage at which a retrieval request of the second terminal is responded for primary selection of the first information, a type of a user value to initially achieve spatial diversity of candidate information.

The policy construction unit may further be configured to: receive the retrieval request of the second terminal, and determine a type of a user of the second terminal according to a first preset rule; when the type of the user of the second terminal is a low value type, skip responding to the retrieval request, or respond to the retrieval request, obtain, by parsing, a quantity X of candidate information requests in the retrieval request, and return Y pieces of candidate information, where X>Y; and when the type of the user of the second terminal is a high value type, respond to the retrieval request, obtain, by parsing, a quantity M of candidate information requests in the retrieval request, and return N pieces of candidate information, where M<N.

The policy construction unit may further be configured to: perform, in a processing node corresponding to a stage at which a retrieval request of the second terminal is responded for fine selection and ranking of the first information, diversity optimization on spatial differentiation of candidate information according to a second preset rule based on multiple candidate information positions displayed on a page, and perform formal uniformization on the candidate information in space and time.

The policy construction unit may further be configured to: determine priorities among multiple candidate information positions, rank the multiple candidate information positions according to an order of the priorities, to obtain an information position combination, correspond each of the multiple candidate information positions to one candidate information queue, and mark candidate information located at the first position in each candidate information queue as first specified information; traverse the first specified information in the candidate information queues corresponding to the candidate information positions one by one, perform, according to different dimensions, diversity determining and matching with candidate information that has been selected, to remove duplicated information, and when all the information satisfies a filtering rule, add candidate information obtained after duplication-removal processing to an information queue obtained after duplication-removal processing; preferentially fill the first position that is in the candidate information queue corresponding to each candidate information position and that has a highest exposure probability, and for a position that is not the first position, sequentially determine, according to the order of the priorities, whether there is a diversity conflict between candidate information and a candidate information queue for an information position that has been filled and that is not the current information position, if there is no conflict, fill the position with the candidate information; otherwise place the candidate information into the information queue obtained after duplication-removal processing; and fill positions with candidate information until a candidate information queue having a length required by each candidate information position is filled to the full, and if the candidate information queue is not filled to the full, supplement, according to a conflict order, the candidate information queue with candidate information in the information queue obtained after duplication-removal processing, so as to obtain, from the multiple candidate information queues, an information combination with a differentiation degree distance greater than a threshold.

The policy construction unit may further be configured to: in a processing node corresponding to a stage at which a retrieval request of the second terminal is responded for fine selection and ranking of the first information, set a first time period T0 and/or a second time period T1, where T1>T0; collect a negative feedback request reported by the second terminal, where the negative feedback request is generated in response to a user closes one or more pieces of presented specified information; perform negative feedback filtering when it is detected that it is currently within the first time period T0, skip returning the one or more pieces of presented specified information within the first time period T0; and perform negative feedback filtering when it is detected that it is currently within the second time period T1, support returning the one or more pieces of presented specified information within the second time period T1, and gradually reduce a quantity of returning times or returning frequency or a specific quantity of the returned pieces of presented specified information according to a time control factor.

### Embodiment 6

The foregoing second terminal for advertisement information presentation that is on the user side may be an electronic device such as a PC, or may be a portable electronic device such as a PAD, a tablet computer, or a portable computer, or may be a smart mobile terminal such as a mobile phone, which is not limited to the description herein. The server may be an electronic device that is formed by a cluster system and that integrates the functions of the units or separately implements the functions of the units. Both the client and the server include at least a database for data storage and a processor for data processing, or include a storage medium that is disposed in the server or a storage medium that is independently disposed.

For the processor for data processing, a microprocessor, a central processing unit (CPU), a digital signal processor (DSP), or a field-programmable gate array (FPGA) may be used to perform processing. The storage medium includes operation instructions, where the operation instructions may be computer executable code, and are used to implement the steps in the processes of the information processing methods in the foregoing embodiments of the present disclosure.

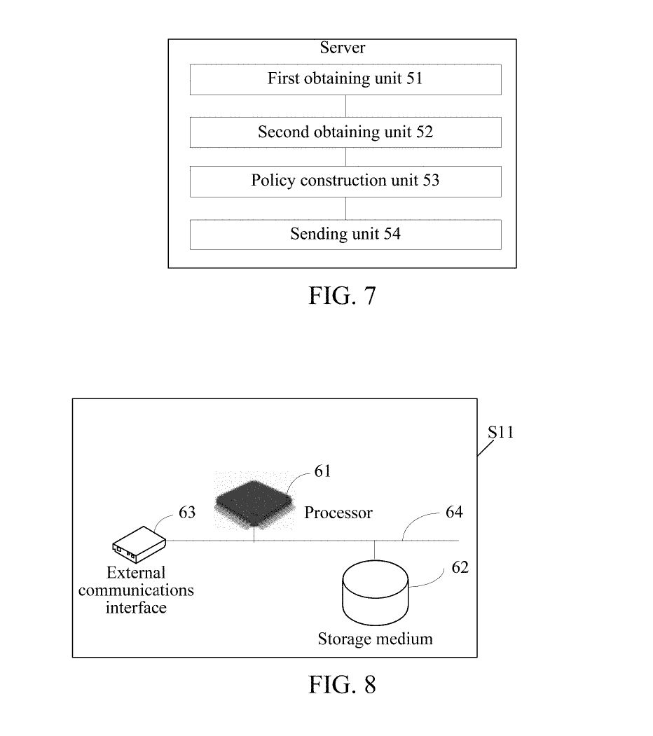

An example in which the second terminal and the server are used as a hardware entity S11 is shown in FIG. 8. The apparatus includes a processor 61, a storage medium 62, and at least one external communications interface 63. The processor 61, the storage medium 62, and the external communications interface 63 are all connected by using a bus 64.

### Embodiment 7

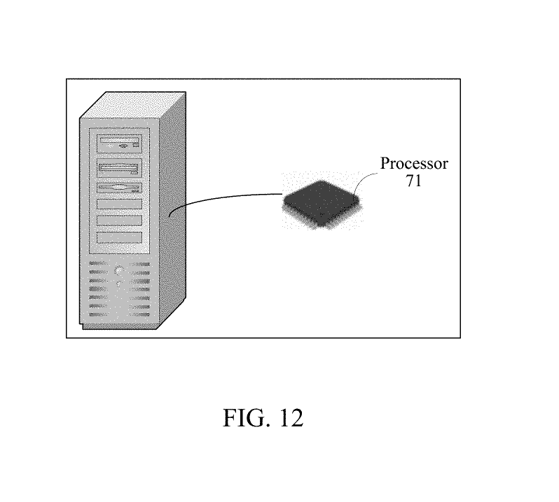

A server provided in this embodiment of the present disclosure is shown in FIG. 12. The server includes a processor 71, configured to perform the following operations by using executable instructions:

obtaining first information from a first terminal, the first information including at least information content and an information presentation style parameter;

obtaining second information from the second terminal, the second information including at least basic user information and/or user behavior information and/or user relationship chain information;

generating sampling information according to the first information and the second information, and constructing, according to the sampling information, at least one processing policy that separately corresponds to a first type of processing node interacting with the first terminal and a second type of processing node interacting with the second terminal; and

generating the third information according to the first information and the at least one processing policy, and sending the third information to the second terminal for information presentation.

Correspondingly, a computer storage medium provided in an embodiment of the present disclosure stores a computer program, and the computer program is configured to execute the foregoing information processing method.

It should be noted herein that, the foregoing description related to the server is similar to the foregoing description for the method, and beneficial effects are similar to those of the method, and details are not described herein again. For technical details that are not disclosed in server embodiments of the present disclosure, refer to the descriptions in the method embodiments of the present disclosure.

The embodiments of the present disclosure are elucidated below by using an actual application scenario as an example.

An example in which information content presented on a user side is advertisement information is used. The embodiments of the present disclosure are used in this application scenario, and the application scenario is specifically an optimized solution for targeted advertising for social advertisement users based on a social network. Some terms are involved in the following specific instance, and are explained herein. 1) GDT (GuangDianTong) is a social advertisement platform based on the Tencent social network system. By using GDT, a user may can advertise advertisements on a variety of platforms such as QQ Zone, QQ client, mobile Qzone, mobile QQ, WeChat official account, WeChat friend circle, QQ Music client, and QQ News client for product promotion. 2) A Return On Investment (ROI) is a value that should be returned by investment. 3) A user persona is user-related data such as user basic population attributes, behavior features, and interest labels that is mined by the Tencent GDT advertisement platform by integrating big data provided by Tencent/Tencent-related Internet products. The user persona provides a user data service for an advertising system. 4) A basic advertising service refers to a related tool and service that is provided for an advertising system by performing feature analysis on titles, descriptions, material, and landing pages in advertisement material, constructing advertisement end feature sets, and describing advertisement attributes based on advertisement base statistics collection and analysis. A Predict CTR: In one aspect, the pCtr needs data of an advertisement, and in another aspect, the pCtr needs data of a user, and the data in the two aspects is used to evaluate a possibility that a user clicks on this advertisement. 5) An effective Cost Per Mille is mainly used to measure advertisement presentation efficiency inside an advertising system from the aspect of advertisement exposure prices of advertisements of various charging modes. 6) An Average Revenue Per User (ARRU) refers to revenue that is obtained by exposing an advertisement to users in a time period by an advertisement platform. 7) Temporal diversity refers to maintaining “freshness” of a user for an advertisement in the time dimension, decreasing a probability that the user views repeated and similar advertisements in a short period of time, and reducing aesthetic fatigue of the user. 8) Spatial diversity refers to a differentiation degree of advertisements presented at multiple advertisement positions on a page in response to a same request, and the advertisements are differentiated from the dimensions of advertisement categories, material fingerprints, product subject matters, and advertisement (advertiser) IDs. 9) A negative feedback of a user refers to an entrance that is provided by an advertisement platform to a user for closing an advertisement. A user can close an advertisement in which the user is not interested or report vulgar/false information, and effectively interact with an advertisement platform for experience optimization. 10) An advertisement exposure duration refers to a time during which a user stays on an advertisement after the advertisement is exposed.

In current advertisement information presentation, for advertisement information as recommendation information recommended to a user, interaction of information exchange needs to be formed with the user, so that valuable recommendation information can be better obtained for the user by screening, and can also improve, according to a feedback result of user interaction, a policy for better targeted information recommendation for the user. In consideration of such an interaction mechanism, appropriate advertisement information needs to be presented to the user or inappropriate advertisement information should not be presented to the user. However, in many cases, the interaction mechanism is not considered, but an advisor simply recommends information unilaterally. This is not conducive to sharing and spreading of information, and an information spreading chain cannot be formed by sharing and spreading of the information to provide convenience to the life of the user.

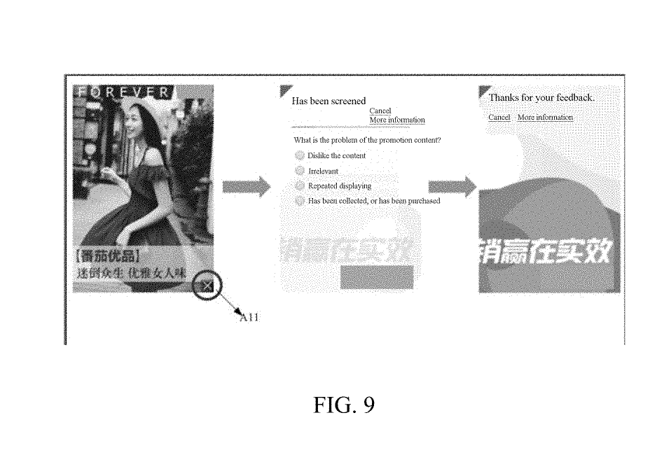

Because advertisement information in the form of a picture is more intuitive than advertisement information in the form of a text, advertisement information is usually presented in the form of a picture. Quality of the picture and precision of advertisement matching personalization become points of interest for desirable interaction with the user. Some Internet advertisement platforms provide a negative feedback entrance, so that a user can select a reason for a negative feedback, and after the user closes an advertisement, the advertisement is no longer presented to the user in a period of time. As shown in FIG. 9, All in FIG. 9 is a negative feedback entrance.

Still for better improvement of an interaction mechanism and therefore precise and targeted advertising of information needed by a user, instead of presentation of advertisement information to the user that the user does not intend to learn without consideration of the will of the user, factors of a user side, an advertiser side, and a third party platform (for example, the GDT platform) for advertisement examination, advertisement screening, and final advertisement advertising need to be taken into account at the same time. For example, information browsing experience of the user, an ROI of the advertiser, and interests of the advertisement platform need to be taken into account. That is, a system environment needs to be built, where the system environment is an ecological system that needs to take interests of the foregoing three parties into consideration at the same time. The advertiser mainly considers an ROI of advertisement advertising. The platform (for example, the GDT platform) has a core target of benefits. The user (browser) pays more attention to whether an advertisement is useful, whether targeting is precise, and whether a picture is favorable. In the balance of the three parties, interests of the advertiser and the advertisement platform both have fixed indicators for quantification, but the experience of the user has no overall and systematic quantification. In the existing technology, quantification of user experience is basically measured by using a click-through rate, but the click-through rate only reflects an acceptance degree of a user for an advertisement from one aspect. In a real platform, different user behaviors reflect feelings of a user for advertisement information in varying degrees. If the advertisement information triggers interest of the user and satisfies a particular requirement of the user, the user may click on the advertisement and further perform a subsequent behavior (for example, ordering or purchasing). If quality of the advertisement information is so vulgar, false, or repeated that the user dislikes the advertisement information, the user may express objection by giving a negative feedback, reporting/complaining, or even leaving the platform, which results in the loss of the user. There are also some users who do not perform any direct behavior such as a click or a negative feedback regardless of which advertisement is viewed by the users in a period of time, regardless of whether the users are interested in the advertisement, and whether experience is good.

The following problems may be known from the foregoing analysis:

First, in the existing technology, user experience can be improved for only users who actively give a feedback, but the existing technology is powerless for a majority of users who do not actively give a feedback. In the present disclosure, user experience can be improved for all users on a social network.

Second, in the existing technology, user experience is considered only in the link of advertisement presentation, and only “handling after an event” can be fulfilled. In the present disclosure, optimization of user experience is performed throughout an entire advertisement life cycle.

Third, in the existing technology, effects on operations indicators such as revenue, a CTR, and a CPM if advertisements are screened to improve user experience are not considered. In the present disclosure, user experience and platform benefits are both taken into account, and the target of all-win of multiple parties is fulfilled.

Fourth, in the existing technology, user experience is not measured by systematic quantification, and user experience is evaluated by using only one indicator of a click-through rate of a user. In the present disclosure, a quantification indicator for measuring user experience of an advertisement on a social network is proposed.

In this application scenario, the embodiments of the present disclosure are used and the foregoing four problems are resolved. There are the following several aspects, and each aspect or several aspects may be used to resolve one or more of the foregoing four problems. In general, benefits of the foregoing user side, the advertiser side, and the platform side are taken into account at the same time, and damage to an ecological environment of products due to material of low quality and irrelevant advertisements is reduced to the greatest extent by using a global optimization policy throughout processing nodes in an advertisement life cycle, so as to better improve an interaction mechanism, and therefore provide precise and targeted advertising of needed information to a user.

In a first aspect, optimization of user experience for an advertisement is performed throughout an entire advertisement life cycle. This can be used to correspondingly resolve the foregoing second problem.

User experience optimization is not single-point policy optimization, and needs to be performed throughout different stages in an advertisement life cycle by taking an overall ecological environment of an advertising system into consideration.

FIG. 3 is still used as example for description. Starting from expansion of advertisers, the scale of an advertisement base should be expanded to the greatest extent, and advertisers in different industries need to be expanded, to improve abundance of the advertisement base. At an examination stage, in addition strict control on qualification of advertisers and advertisement content, material quality further needs to be strictly controlled, and auxiliary examination of basic advertising services needs to be fully utilized, for example, advertisement classification, scoring of material of high and low quality, and targeted relevance determination. User personas are label resources uniquely owned by Tencent, and are of great importance for advertisement matching, advertisement user value determination, and targeting effect optimization. During advertisement retrieval, in addition to that a targeting condition is satisfied, diversity of candidate advertisements may be initially ensured by using policies such as bucketing quotas, face washing, global supplement. In the fine selection and ranking link, advertisement entering permission is further controlled and comprehensive ranking is performed in combination with factors such as a pCtr, an eCPM, and various measures for a platform value/user experience. Before an advertisement is exposed, necessary operational policies (for example, diversity and freshness) further need to be introduced by considering a scenario of a social advertisement. After the advertisement is actually exposed, user experience is iteratively fed, in real time or in an offline manner, back to the foregoing links of the advertisement ecological system by performing data collection, badcase analysis, evaluation and monitoring, and the like on a click behavior of a user, so as to finally form a closed loop, to obtain a policy throughout an entire advertisement cycle.

In a second aspect, user values should be considered in experience optimization. This can be used to correspondingly resolve the foregoing third problem.

In a conventional advertising system, user data is usually used for precise targeting of advertisements, an advertisement CTR evaluation feature, and the like, and identification of user value is not used for advertisement retrieval. For each retrieval request, a system always allocates corresponding computing resources according to a retrieval logic and an operational model that are configured in advance, to obtain, by screening, an advertisement set for which the platform theoretically has optimal benefits and present the advertisement set to users. Such a manner in which values of users are not differentiated causes insufficient usage of “advertisement service resources”. For example, for users that are not quite active, it is difficult to bring actual benefits to a platform and an advertiser in a short period of time even when advertisements in which the users are actually interested are presented, and more advertising computing resources need to be inclined for those active users who perform (positive/negative) click behaviors.

For the GDT advertising platform based on precise user targeting, user values need to be introduced to measure and differentiate users of high and low values. This is a fundamental dimension for user experience optimization. A user value is mainly measured according to a contribution of a user to benefits of the platform. A basic operational indicator may be referred to when the user value is defined, and a score may be given based on a CTR, an eCPM, an ARPU, and the like of the user. After the user value is introduced, a user of a high value and a user of a low value are differentiated. Therefore, for users with different priorities, the following different policies may be used for processing respectively, and play a role in the following scenarios:

1) For a user of a low value, when an advertisement retrieval request is initiated, a retrieval may not be performed or a quantity of returned advertisements may be reduced. For a user of a high value, a threshold for an advertisement entering permission queue may be increased, a candidate advertisement queue may be appropriately elongated, and an optimized set may be expanded.

2) For a user of a high value, labels of the user may be enriched by using more resources during offline mining, more resources may be allowed for relevance and CTR prediction module and other modules for precise computing during online computing, and user personalized control may be implemented in links such as temporal/spatial diversity and negative feedback.

3) A user value may further be used as indirect quantification of effects of user experience optimization for advertisements. For example, policy optimization effects are evaluated by monitoring changes in a distribution of user values on the platform and differentiating different groups.

In a third aspect, an experience policy unique to social advertisements: temporal/spatial diversity may be used. This can be used to correspondingly resolve the foregoing third problem.

During use of a social product such as Qzone, repeated or similar advertisements are often seen. Psychologically, because a short-term point of interest of a user is constantly changing, if the user continuously views same or similar advertisements, the user may gradually become less interested in the advertisements, consequently resulting in the “aesthetic fatigue” problem. In a worse case, the user may become bored, or even result in the loss of the user.

Advertisement diversity is a scenario experience unique to advertisements on a social network, and may be understood as abundance of advertisements viewed by a user. From the aspects of time and space, the diversity may further be divided into temporal diversity and spatial diversity.

The temporal diversity is mainly achieved by control of exposure frequency of an advertisement and weight-reduction oppressing of CTR results. In this specification, a spatial diversity optimization policy is proposed based on a scenario of multiple advertisement positions on a page, and benefit optimization is taken into account at the same time, so that a CPM loss is minimized.

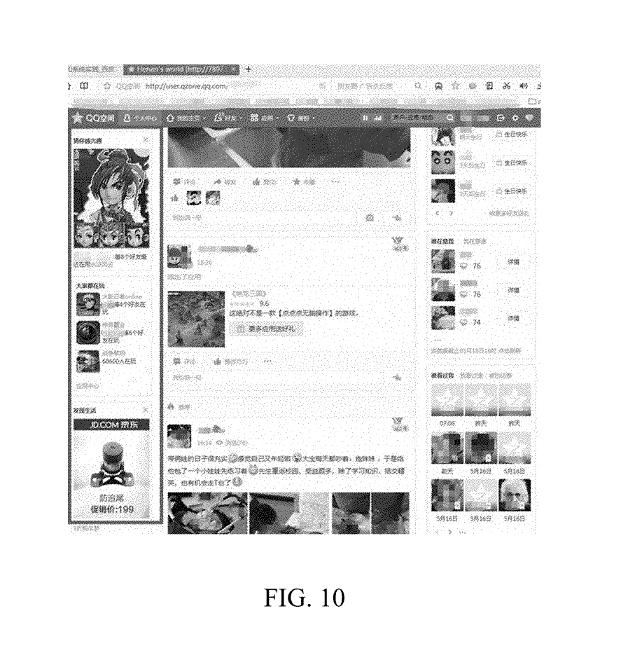

The spatial diversity is differentiated from five dimensions: an advertisement ID, an advertiser ID, a promoted product, an advertisement category, and a material fingerprint. The advertisement ID and the advertiser ID can be uniquely determined by the system, and a mark of the promoted product, the advertisement category, and the material fingerprint are calculated by using an independent algorithm. A left lower corner of My Zone of PC-Qzone is a typical scenario of multiple advertisement positions. As shown in FIG. 10, there are multiple advertisement positions in a left lower corner of My Zone of a Qzone.

From the aspect of background implementation of advertisements, each advertisement position corresponds to one candidate advertisement queue. The goal herein is to dynamically select, from multiple candidate advertisement queues, an advertisement combination that satisfies a spatial diversity definition and has optimal benefits (there is no diversity problem inside a same advertisement position queue). Referring to FIG. 6B, a policy for achieving spatial diversity is specifically described as follows:

1) Priorities (for advertisement filling) among multiple advertisement positions in a diversity scenario is dynamically determined, and the advertisement positions are ranked according to eCPM×Quality of top-1 advertisements in advertisement position queues. The ranked advertisement positions are sequentially denoted as pos_1, pos_2, pos_3, and . . . , and numbers of advertisements in a finely selected advertisement queue corresponding to each advertisement position are Adi1, Adi2, Adi3, and . . . (i represents the i^{th} advertisement position).

2) The top-1 advertisements at the advertisement positions are traversed one by one, and diversity is determined in combination with selected advertisements by using a diversity determination policy. A specific method is determining diversity by using filtering functions in different dimensions, and the advertisement may be selected if all filtering conditions are satisfied.

3) Each advertisement position is preferentially filled with a top-1 position advertisement having a maximum exposure probability.

4) For remaining positions that are not for the top-1 position advertisement, ranking is performed according to the priorities of the advertisement positions, and whether there is a diversity conflict between an advertisement and advertisement queues for advertisement positions that have been filled and that are not the current advertisement position is sequentially determined, and if there is no conflict, the advertisement position is filled with the advertisement; otherwise, the advertisement is placed into a filter_vec queue (for a supplementing policy).

5) Positions are filled until an advertisement queue having a length required by the advertisement position is filled to the full, and if the advertisement queue is not filled to the full, the advertisement queue is supplemented with an advertisement in the filter_vec queue according to a particular conflict order.

By using the spatial diversity optimization policy, gray publication and full publication are implemented by an experimental system. A loss in an advertisement CPM is controlled to be within 5%, and a CTR is improved to some extent. A percentage of advertisements of a same category that are exposed at the same time is decreased from approximately 20% to lower than 2%, and user experience is greatly improved.

The problem of spatial diversity is first resolved, and the temporal diversity may further be considered. An association between the spatial diversity and the temporal diversity may be established. For example, generally speaking, the spatial diversity is achieved by using a first policy, the temporal diversity is achieved by using a second policy, and a combination of the spatial diversity and the temporal diversity is achieved by using a third policy (the third policy=the first policy+the second policy). The obtained third policy may not necessarily be in the form of the imposition of the first policy and the second policy, but may be in another policy optimization combination form. When both the spatial diversity and the temporal diversity are combined, in an actual implementation, neighboring dimensions are considered, and a rule combination may be completely replaced with an eigenvector, to achieve formal definition uniformization of the spatial diversity and the temporal diversity. For this purpose, the concept of a “differentiation degree” distance between advertisements is defined as follows:

For the “differentiation degree” distance, Di represents an advertisement whose differentiation eigenvector is I, where I has n dimensions, and n is a quantity of feature dimensions measuring advertisement differentiation (which encompass dimensions of a temporal/spatial diversity rule), and t represents a feature in a particular dimension. Therefore, a general advertisement diversity rule may be expressed as: an advertisement combination whose “differentiation degree” distance is greater than a particular threshold.

In a fourth aspect, a negative feedback may be given for an advertisement. This can be used to correspondingly resolve the foregoing first problem.

The GDT advertising platform has supported a negative feedback function for PC-Qzone and a feeds information stream, and can record a negative feedback behavior of each user for each advertisement position. An online policy is implemented in a fine selection and ranking module, and processing policies at two stages are designed in the time dimension currently.

Stage T0: A time period T0 is set, and an advertisement for which a negative feedback is given is filtered out according to dimensions such as an advertisement ID, an advertisement category, and an advertised product, so that the advertisement for which the negative feedback is given is not viewed by a user forcibly. That is, for an advertisement that has been closed by a user by using a negative feedback entrance, the advertisement is no longer advertised to the user in the stage T0, and an advertising probability is zero.

Stage T1: A time period T1 is set (after T0), and weight-deduction oppressing is implemented according to a time factor, so as to decrease an exposure opportunity of an advertisement for which a user gives a negative feedback. That is, for an advertisement that has been closed by a user by using a negative feedback entrance, the advertisement may be advertised to the user again at the stage T1 after T0 according to a policy, to increase an advertising probability. However, the advertising of the advertisement cannot be excessively frequent, and advertising frequency should be lower than a threshold.

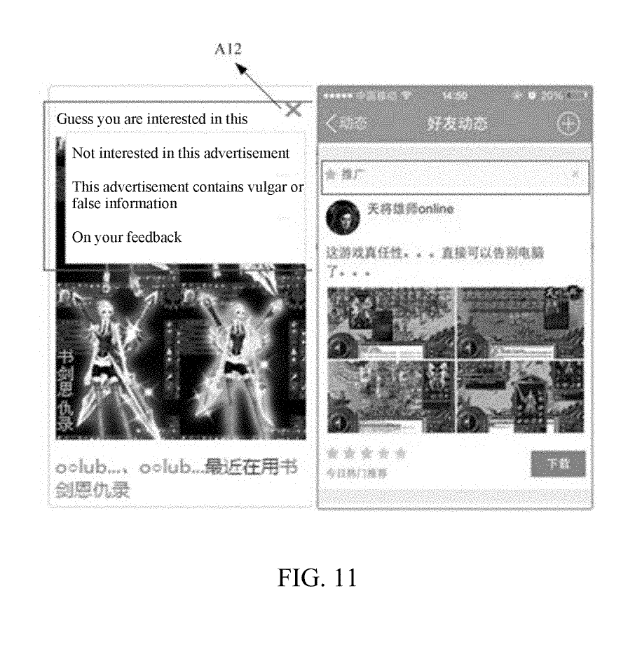

Another form of a negative feedback entrance different from that in FIG. 9 is shown in FIG. 11. A12 in FIG. 11 is a negative feedback entrance.

A negative feedback directly reflects boredom of a user for a current advertisement (certainly, there are also some users who do not click on a negative feedback even the users dislike an advertisement). By means of feature analysis for negative feedback users, analysis of negative feedback advertisements, and research on a negative feedback rate, a background policy can further be implemented by using a model. That is, similar to CTR prediction, an advertisement negative feedback rate may be predicted, and the user experience factor, the negative feedback rate, may be introduced in a broadcast policy and in a bidding ranking process.

In a fifth aspect, quality permission and exposure control are employed at a fine selection stage. This can be used to correspondingly resolve the foregoing third problem.

At the fine selection stage, advertisements are ranked according to composite scores. To obtain the composite scores, factors such as experience, benefits, and platform values are considered. However, other rank adjustment rules after ranking, for example, policies such as a mandatory recall of a special advertisement, temporal/spatial diversity, and a negative feedback further cause some advertisements having a low CTR and a low eCPM to have an opportunity to be adjusted to the front of an exposure queue, consequently affecting user experience.

Taking both user experience and platform benefits into consideration, by controlling entering permission of a finely selected advertisement queue (which may be in the form of an advertisement queue in FIG. 6B, but is not limited to the form), “absolutely” low-quality advertisements are filtered out, and by controlling exiting permission from an advertisement exposure queue, exposure of advertisements having low composite benefits is reduced. It is designed to improve user experience, for example, a decrease in an advertisement negative feedback rate, by means of controllable exposure and a revenue loss. A group of small-flow experiments in which filtering is performed according to an eCPM threshold indicate that, by appropriately controlling exposure reduction and a revenue loss of advertisements of low quality, an effective decrease in a negative feedback rate can be achieved, thereby improving user experience.

The advertisement entering permission control does not affect subsequent ranking by using various fine selection policies, and quality of an advertisement queue can be effectively ensured. The advertisement exiting permission control directly affects exposure, but may damage effects of policies such as diversity to some extent. For the control of entering permission and exiting permission of advertisements, several criteria need to be considered: 1) a CTR, which is widely recognized in the industry, and reflects a favor of a user for an advertisement; 2) an eCPM, so as to take both the CTR and platform benefits into consideration; and 3) an advertisement composite score (eCPM×quality), so as to take factors affecting advertisement ranking into consideration. The quality collectively refers to platform value factors such as a CVR and external links.

Threshold setting is implemented by using two stages: static setting and dynamic modification. An example in which entering permission control is performed according to a pCtr. At the first stage, a CTR distribution condition of key traffic and key advertisement positions may be analyzed in an offline manner, and an appropriate threshold is selected to initiate multiple groups of experiments for debugging. At the second stage, real-time monitoring and data pipeline of entering permission control data are implemented, and a data distribution of historical exposure conditions is periodically calculated to give a new threshold for use online. To set a precise dynamic threshold, a model prediction may also be considered.

In a sixth aspect, advertisement user experience is utilized in bidding ranking. This can be used to correspondingly resolve the foregoing third problem.

A bidding ranking formula includes the following two formulas: a formula (1) and a formula (2). The formula (1) is a GSP model, and the formula (2) is a VCG model.

score=eCPM×quality Formula (1)

Charging modes such as CPA, CPC, and CPM may all be reduced by formal uniformization to CPM, which is understood as platform benefits. The quality is a quality score introduced in combination with a service, aiming to balance benefits of the platform and advertisers. For design of the quality, factors such as landing page quality/relevance may be considered. For the GDT platform, factors such as advertisement quality, external links, and platform values are further considered in combination with specific services.

For example, in consideration of a target and effects of a user experience factor in ranking, a subscore may be introduced in the quality, which has a same function as other quality factors (factors related to user experience). A user experience value itself has physical significance. After an advertisement is exposed to a user, direct (and long-term) positive experience and experience benefits or negative experience and an experience loss may be brought to the user/platform. When overall user experience benefits E(A, U, C)>0, the advertisement may be exposed. When E(A, U, C)<0, exiting permission should be controlled and exposure should be restrained. The VCG model encourages an advertiser to offer a price according to a real will.

score=basic_eCPM+quality eCPM Formula (2)

basic_eCPM is converted from a real bid, and a corresponding bill needs to be undertaken by an advertiser. quality_eCPM is converted from a quality factor, and such a “bill” should be “paid” by the platform system, and does not need to be undertaken by the advertiser. Same as the GSP model, the quality herein is also a quality score and a platform value that are introduced in combination with a service. Overall user experience benefits as a part of quality_eCPM is defined as a formula (3):

experience_eCPM=PR×PR_bid−NR×NR_bid Formula (3)

PR represents a positive user experience probability, PR_bid represents experience benefits, NR represents a negative experience probability, for example, a negative feedback, and NR_bid represents an experience loss.

In a first aspect, quantification and statistics collection and monitoring of optimization effects of user experience for an advertisement are performed. This can be used to correspondingly resolve the foregoing fourth problem.

For measurement of policy optimization effects of user experience, it is difficult to summarize improvements in various aspects by using one value. A comprehensive evaluation may be given from aspects such as an operational indicator, offline statistics collection, and third-party evaluation. Only indicators for clicking are used currently, which include, but are not limited to, the following indicators:

1) An advertisement like rate. For a social advertisement, interaction between users and the advertisement is a notable feature. Users may actively like an advertisement in which the users are strongly interested. Therefore, the advertisement like rate is a quite good indicator for measuring advertisement experience.

2) An advertisement click-through rate. If a presented advertisement is attractive to users, this may be partially manifested as an increase in a click-through rate. An advertisement (temporal/spatial) diversity policy may be implemented at a fine selection and ranking stage, or may be integrated into a click-through rate prediction module. In a click-through rate prediction process, advertisement diversity related features are introduced, and a click-through rate is reflected by a pCtr result, coupling among rules in a fine selection and ranking process is reduced, and user experience may also be improved to improve an interaction mechanism. In addition, a diversity policy not only may be applied to advertisement experience optimization of multiple advertisement positions on a same page, but also may be used for an advertisement recommendation system. Differentiated subject content are recommended for user interests and time sequence behaviors.

3) An advertisement negative feedback rate. If a user dislikes an advertisement, the user may perform a negative feedback operation, or may do nothing at all (or a negative feedback function is not supported, and nothing can be done). A decrease in the negative feedback rate can only partially reflect an improvement in user experience.

4) An advertisement exposure duration. A preference of a user for an advertisement may be reflected by direct behaviors of a like, a click, or a negative feedback, but in many cases, the user may not produce a direct behavior due to various reasons. The advertisement exposure duration is a time for which a user stays on an advertisement. A long retention time indicates that the user is attentive for the advertisement, and a short retention time indicates to some extent that the user is not interested in the advertisement.

5) User activeness. Herein, the user activeness may be obtained by cooperation with a product team on the platform, and a user activeness indicator defined by the product team may be used as a measure for user experience. For example, different user experience policies are compared, and a change in an activeness indicator of users on the platform may be obtained by comparison in cases in which an advertisement is/is not presented to sampled users.

6) Monitoring indicators at different stages. An advertisement category distribution, a low-quality material percentage, and the like at different stages such as advertisement storage, primary selection, fine selection, and exposure may be monitored.

7) Manual evaluation. A manual evaluation system is built, real user accesses are simulated, and statistics on a badcase percentage is collected.

8) Case comparison. In a release process of a significant policy improvement version, a QQ number may be bound to experience and compare effects.

9) Public sentiment monitoring. Sensitivity to comments, scores, complaints for a product by users inside and outside a company should be maintained for better user feeling analysis.

In this application scenario, by using the embodiments of the present disclosure, an interaction mechanism in advertisement information recommendation and advertising processes is improved, to achieve effects of precise and targeted advertising, which is a three-party balance among a user side, an advertiser side, and a platform. A closed-loop ecological environment for cyclic and iterative feedback is created, and policy optimization is performed throughout various processing nodes in an advertisement life cycle, instead of policy optimization at one to two points. In addition, a user value is added to entire policy optimization, and an advertisement diversity experience optimization policy is given based on a scenario of multiple advertisement positions on a page, for balancing with platform benefits. Moreover, spatial diversity and temporal diversity (freshness) policies are formally uniformized, a policy for filtering and oppressing of an advertisement negative feedback function is provided, a negative feedback quantification evaluation indicator is provided, a quality permission policy at an advertisement fine selection stage and an exposure control experience optimization policy are proposed, a target and effects of user experience in an advertisement bidding ranking process are given, and policies for quantification and statistics collection monitoring of advertisement user experience optimization effects and the like are provided. In this way, the interaction mechanism is improved by using these policies, to achieve the effects of precise and targeted advertising.

In the several embodiments provided in this application, it should be understood that, the disclosed devices and methods may be implemented in other manners. The device embodiments described above are merely illustrative. For example, the division of the units is only a division of logical functions. In actual implementations, there may be another division manner. For example, multiple units or components may be combined, or may be integrated into another system, or some features may be omitted, or not implemented. In addition, the coupling or direct coupling or communication connection among the compositional parts displayed or discussed may be implemented by using some interfaces. The indirect coupling or communication connection among the devices or the units may be electrical, mechanical, or in another form.

The foregoing units described as separate parts may be or may not be physically separate, and the components displayed as units may be or may not be physical units. The units may be located at one place, or may be distributed in multiple network units. Some or all of the units may be selected according to an actual requirement to fulfill the purposes of the solutions of the embodiments.

In addition, the functional units in the embodiments of the present disclosure may all be integrated in one processing unit, or each unit may be separately used as one unit, or two or more units may be integrated in one unit. The integrated units may be implemented in the form of hardware, or may be implemented in the form of hardware in combination with software functional units.

It may be understood by a person of ordinary skill in the art that, all or some of the steps of the foregoing embodiments may be implemented by a program instructing relevant hardware. The program may be stored in a computer readable storage medium, and when the program is executed, the steps including the embodiments are performed. The storage medium may include various types of media that can store program code such as a mobile storage device, a read-only memory (ROM), a random access memory (RAM), a magnetic disk, or an optical disc.

Alternatively, if implemented in the form of software functional modules and sold or used as independent products, the integrated units in the present disclosure may also be stored in a computer readable storage medium. Based on such an understanding, essentials or parts contributing to the existing technology of the technical solutions in the embodiments of the present disclosure may be embodied in the form of a software product. The computer software product is stored in a storage medium, and includes several instructions used to cause a computer device (which may be a personal computer, a server, or a network device) to execute all or a part of the method described in the embodiments of the present disclosure. The storage medium includes various types of media that can store program code such as a mobile storage device, a ROM, a RAM, a magnetic disk, or an optical disc.

What is described above is merely specific implementations of the present disclosure, but the protection scope of the present disclosure is not limited to this. Changes or replacements easily occurring to any person skilled in the art within the technical scope disclosed in the present disclosure shall be covered by the protection scope of the present disclosure. Therefore, the protection scope of the present disclosure shall subject to the protection scope of the claims.

By means of the embodiments of the present disclosure, sampling information is generated by using first information and second information, at least one processing policy that separately corresponds to a first type of processing node interacting with a first terminal and a second type of processing node interacting with a second terminal is constructed according to the sampling information, and the third information provided to the second terminal for information presentation is generated according to the processing policy. Such a global processing policy for information collection and targeted information pushing can provide precise information recommendation content to a user.

What is claimed is:

1. A method for processing information, comprising:
obtaining, by a device comprising a memory and a processor in communication with the processor, first information from a first terminal, the first information comprising at least information content and an information presentation style parameter;
obtaining, by the device, second information from a second terminal, the second information comprising at least one of:
basic user information,
user behavior information, or
user relationship chain information;
generating, by the device, sampling information according to the first information and the second information;
constructing, by the device according to the sampling information, at least one processing policy that separately corresponds to a first type of processing node interacting with the first terminal and a second type of processing node interacting with the second terminal;
generating, by the device according to the first information and the at least one processing policy, third information comprising presentation information for the second terminal; and
sending, by the device, the third information to the second terminal for information presentation.

2. The method according to claim 1, further comprising:
receiving, by the device, an information presentation result from the second terminal;
feeding, by the device, the information presentation result to the first type of processing node and the second type of processing node; and
optimizing, by the device, the at least one processing policy at the first type of processing node and the second type of processing node to form a closed-loop policy control processing mechanism, wherein the first type of processing node and the second type of processing node are processing nodes in an information recommendation and sharing platform system that represent information life cycles.

3. The method according to claim 1, further comprising:
performing, by the device, feature analysis on the first information in the sampling information to generate a first feature set;
performing, by the device, feature classification according to a feature attribute;
performing, by the device, data analysis on the second information in the sampling information to generate a first data set;
performing, by the device, data classification according to a data type;
establishing, by the device, a targeted recommendation association according to the feature classification and the data classification; and
iteratively feeding, by the device, the targeted recommendation association back to the first type of processing node and the second type of processing node.

4. The method according to claim 1, wherein the first type of processing node comprises at least one of the following:
a processing node corresponding to a stage at which a user of the first terminal is expanded; or
a processing node corresponding to a stage at which the first information provided by a user of the first terminal is examined.

5. The method according to claim 1, wherein the second type of processing node comprises at least one of the following:
a processing node corresponding to a stage at which a retrieval request of the second terminal is responded for primary selection of the first information;
a processing node corresponding to a stage at which a retrieval request of the second terminal is responded for fine selection and ranking of the first information;
a processing node corresponding to a stage that is before the third information is sent to the second terminal for exposure; or
a processing node corresponding to a stage that is after the third information is sent to the second terminal for actual exposure.

6. The method according to claim 1, wherein the constructing, by the device according to the sampling information, the at least one processing policy that separately corresponds to the first type of processing node interacting with the first terminal and the second type of processing node interacting with the second terminal comprises:
creating, by the device in a processing node corresponding to a stage at which a user of the first terminal is expanded, an information base featuring both type differentiation and big data according to the first information; and
differentiating, by the device, a priority of a user of the first terminal in a processing node corresponding to a stage at which the first information provided by the user of the first terminal is examined, and performing, by the device, estimation and targeted relevance prediction on information content of the first information according to a quality index.

7. The method according to claim 1, wherein the constructing, by the device according to the sampling information, the at least one processing policy that separately corresponds to the first type of processing node interacting with the first terminal and the second type of processing node interacting with the second terminal comprises one of the following:
creating, by the device in a processing node corresponding to a stage at which a user of the first terminal is expanded, an information base featuring both type differentiation and big data according to the first information; or
differentiating, by the device, a priority of a user of the first terminal in a processing node corresponding to a stage at which the first information provided by the user of the first terminal is examined, and performing, by the device, estimation and targeted relevance prediction on information content of the first information according to a quality index.

8. The method according to claim 1, wherein the constructing, by the device according to the sampling information, the at least one processing policy that separately corresponds to the first type of processing node interacting with the first terminal and the second type of processing node interacting with the second terminal comprises:
differentiating, by the device in a processing node corresponding to a stage at which a retrieval request of the second terminal is responded for primary selection of the first information, a type of a user value to initially achieve spatial diversity of candidate information.

9. The method according to claim 8, wherein the differentiating the type of the user value to initially achieve the spatial diversity of candidate information comprises:
receiving, by the device, the retrieval request of the second terminal;
determining, by the device, a type of a user of the second terminal according to a first preset rule;
when it is determined that the type of the user of the second terminal is a low value type:
skipping, by the device, responding to the retrieval request, or
responding, by the device, to the retrieval request, obtaining, by parsing, a quantity X of candidate information requests in the retrieval request, and returning Y pieces of candidate information, wherein X>Y; and
when it is determined that the type of the user of the second terminal is a high value type:
responding, by the device, to the retrieval request,
obtaining, by the device, by parsing, a quantity M of candidate information requests in the retrieval request, and
returning, by the device, N pieces of candidate information, wherein M<N.

10. The method according to claim 1, wherein the constructing, by the device according to the sampling information, the at least one processing policy that separately corresponds to the first type of processing node interacting with the first terminal and the second type of processing node interacting with the second terminal comprises:
performing, by the device in a processing node corresponding to a stage at which a retrieval request of the second terminal is responded for fine selection and ranking of the first information, diversity optimization on spatial differentiation of candidate information according to a second preset rule based on multiple candidate information positions displayed on a page; and
performing, by the device, formal uniformization on the candidate information in space and time.

11. An apparatus, comprising:
a memory storing instructions;
a processor in communication with the memory, wherein, when the processor executes the instructions, the processor is configured to cause the apparatus to:
obtain first information from a first terminal, the first information comprising at least information content and an information presentation style parameter;
obtain second information from a second terminal, the second information comprising at least one of:
basic user information,
user behavior information, or
user relationship chain information;
generate sampling information according to the first information and the second information;
construct, according to the sampling information, at least one processing policy that separately corresponds to a first type of processing node interacting with the first terminal and a second type of processing node interacting with the second terminal;
generate third information comprising presentation information for the second terminal according to the first information and the at least one processing policy; and
send the third information to the second terminal for information presentation.

12. The apparatus according to claim 11, wherein, when the processor executes the instructions, the processor is further configured to cause the apparatus to:
receive an information presentation result from the second terminal;
feed the information presentation result to the first type of processing node and the second type of processing node; and
optimize the at least one processing policy at the first type of processing node and the second type of processing node to form a closed-loop policy control processing mechanism, wherein the first type of processing node and the second type of processing node are processing nodes in an information recommendation and sharing platform system that represent information life cycles.

13. The apparatus according to claim 11, wherein, when the processor executes the instructions, the processor is further configured to cause the apparatus to:
perform feature analysis on the first information in the sampling information to generate a first feature set;
perform feature classification according to a feature attribute;
perform data analysis on the second information in the sampling information to generate a first data set;
perform data classification according to a data type;
establishing a targeted recommendation association according to the feature classification and the data classification; and
iteratively feeding the targeted recommendation association back to the first type of processing node and the second type of processing node.

14. The apparatus according to claim 11, wherein the first type of processing node comprises at least one of the following:
a processing node corresponding to a stage at which a user of the first terminal is expanded; or
a processing node corresponding to a stage at which the first information provided by a user of the first terminal is examined.

15. The apparatus according to claim 11, wherein the second type of processing node comprises at least one of the following:
a processing node corresponding to a stage at which a retrieval request of the second terminal is responded for primary selection of the first information;
a processing node corresponding to a stage at which a retrieval request of the second terminal is responded for fine selection and ranking of the first information;
a processing node corresponding to a stage that is before the third information is sent to the second terminal for exposure; or
a processing node corresponding to a stage that is after the third information is sent to the second terminal for exposure.

16. The apparatus according to claim 11, wherein, when the processor executes the instructions, the processor is further configured to cause the apparatus to:
create, in a processing node corresponding to a stage at which a user of the first terminal is expanded, an information base featuring both type differentiation and big data according to the first information; and
differentiate a priority of a user of the first terminal in a processing node corresponding to a stage at which the first information provided by the user of the first terminal is examined, and performing estimation and targeted relevance prediction on information content of the first information according to a quality index.

17. The apparatus according to claim 11, wherein, when the processor executes the instructions, the processor is further configured to cause the apparatus to:
create, in a processing node corresponding to a stage at which a user of the first terminal is expanded, an information base featuring both type differentiation and big data according to the first information; or
differentiate a priority of a user of the first terminal in a processing node corresponding to a stage at which the first information provided by the user of the first terminal is examined, and performing estimation and targeted relevance prediction on information content of the first information according to a quality index.

18. The apparatus according to claim 11, wherein, when the processor executes the instructions, the processor is further configured to cause the apparatus to:
differentiate, in a processing node corresponding to a stage at which a retrieval request of the second terminal is responded for primary selection of the first information, a type of a user value to initially achieve spatial diversity of candidate information.

19. The apparatus according to claim 18, wherein, when the processor executes the instructions, the processor is further configured to cause the apparatus to:
receive the retrieval request of the second terminal;
determine a type of a user of the second terminal according to a first preset rule;
when it is determined that the type of the user of the second terminal is a low value type:
skip responding to the retrieval request, or
respond to the retrieval request, obtain, by parsing, a quantity X of candidate information requests in the retrieval request, and return Y pieces of candidate information, wherein X>Y; and
when it is determined that the type of the user of the second terminal is a high value type:
respond to the retrieval request,
obtain, by parsing, a quantity M of candidate information requests in the retrieval request, and
return N pieces of candidate information, wherein M<N.

20. A non-transitory computer readable storage medium storing computer executable instructions, wherein, the computer executable instructions, when executed by one or more processors, are configured to cause the one or more processors to perform:
obtaining first information from a first terminal, the first information comprising at least information content and an information presentation style parameter;
obtaining second information from a second terminal, the second information comprising at least one of:
basic user information,
user behavior information, or
user relationship chain information;
generating sampling information according to the first information and the second information;
constructing, according to the sampling information, at least one processing policy that separately corresponds to a first type of processing node interacting with the first terminal and a second type of processing node interacting with the second terminal;
generating, according to the first information and the at least one processing policy, third information comprising presentation information for the second terminal; and
sending the third information to the second terminal for information presentation.
